(19) United States
(12) Patent Application Publication
(10) Pub. No.: US 2017/0007972 A1
(43) Pub. Date: Jan. 12, 2017

(54) Magnetic Stirring Device and Method of Using the Same

(71) Applicants: Linsheng Walter Tien, Irvine, CA (US); Nick J. Manesis, San Ramon, CA (US); Gene H. Huang, Irvine, CA (US)

(72) Inventors: Linsheng Walter Tien, Irvine, CA (US); Nick J. Manesis, San Ramon, CA (US); Gene H. Huang, Irvine, CA (US)

(21) Appl. No.: 15/175,517

(22) Filed: Jun. 7, 2016

Related U.S. Application Data
(63) Continuation of application No. 12/525,796, filed on Oct. 28, 2009, now abandoned.
(60) Provisional application No. 60/888,941, filed on Feb. 8, 2007.
(60) Provisional application No. 60/941,687, filed on Jun. 3, 2007.

(51) Int. Cl. B01F 13/08

(52) U.S. Cl. CPC B01F 13/0818; B01F 2215/0037

(57) ABSTRACT

Magnetic stirring devices, such as magnetic stirring elements and magnetic stirring systems, and stirring methods where enhanced stability and mixing efficiency is made possible by using magnets that are magnetized through thickness in relation to the rotation axis so as to improve torque and magnetic field coverage. In addition, stirring elements having protruding structures such as blades and support legs are used to improve stirring efficiency.

### CROSS-REFERENCE TO RELATED APPLICATIONS

This application claims priority to, and is a continuation of U.S. Non-Provisional patent application Ser. No. 12/525,796, filed on Oct. 28, 2009, which is the national stage application of PCT application No. PCT/US08/53302, which claims priority to U.S. Provisional Pat. No. 60/888,941, filed on Feb. 8, 2007, and U.S. Provisional Pat. No. 60/941,687, filed Jun. 3, 2007, all of which are hereby incorporated by reference in their entirety. Although incorporated by reference in its entirety, no arguments or disclaimers made in the parent application apply to this application. Any disclaimer that may have been included in the specification of the above-referenced applications is hereby expressly rescinded.

### FIELD OF THE DISCLOSURE

The present invention relates generally to magnetic stirring devices and methods. More particularly, the invention relates to magnetic stirring elements (to which the inventors call the “stir-free” stirring element), and magnetic stirring systems (to which the inventors call the “spin-free” stirring system), and methods that are effective in stirring and/or dispersing two or more phases or compositions comprising two or more phases at high efficiencies while reducing the potential for the magnetic stirring elements to slide, drift, dance, spin off, spin out, or jump in the compositions. Examples of compositions comprise compositions having two or more phases and having two different liquid components, a liquid component and a solid component, two solid components, a gas component and a solid component, or a gas component and a liquid component.

### BACKGROUND

Magnetic stirring elements are frequently used to stir, mix, disperse, or agitate liquid-containing compositions. For example, a container containing a volume of a liquid-containing composition may be placed on a surface of a stirring system, such as a stirrer plate, a stirrer hot plate, or other similar device having a motorized actuator magnet contained therein. A magnetic stirring element is placed in the liquid-containing composition and is caused to rotate by actuation of the motorized actuator magnet. The rotation of the magnetic stirring element results in a vortex being formed in the liquid-containing composition. Examples of magnetic stirring systems or mixing systems are disclosed in the following U.S. Pat. Nos. 3,384,353; 4,162,855; 4,911,556; 5,078,969; 5,120,135; 5,141,327; 5,586,823; 6,109,780; 6,382,827; and 6,467,946, all of which are incorporated herein by reference in their entirety.

Currently available magnetic stirring systems utilize a magnetic stirring element, sometimes referred to as a stirrer or stir bar, that consists of a cylindrical magnet molded into a TEFLON® (PTFE) coating or housing. Although known housing have shapes such as cylinders, crosses, dumbbell shapes, bars, discs, and the like, the housing is frequently, if not always, a bar. Typically, the embedded magnet is relatively small compared to the size of the magnetic stirring element (e.g., the housing is substantially larger than the magnet).

Currently available stirrer plates consist of an actuatable rectangular metal bar with a magnet attached to each end to cause rotation of a magnetic stirring element. The bar can rotate clockwise or counterclockwise. The bar rotates by activating a motor that is coupled to the bar using a controller.

Although a number of magnetic stirring devices, including magnetic stirring elements and magnetic stirrer plates, have been described and are publicly available, existing magnetic stirring elements frequently “spin out”, especially at high speeds of rotation and/or when stirring viscous compositions. Spinning out refers to the magnetic stirring element sliding, drifting, jumping, or otherwise decreasing in rotation about it's vertical rotational axis to provide a vortex in the composition. The magnetic stirring element rotates out of balance and begins to wobble in the container.

In view of the above, it can be appreciated that there continues to be a need for new magnetic stirring devices that have more efficient mixing and reduce or prevent “spin out” of magnetic stirring elements.

All referenced patents, applications and literatures are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply. The invention may seek to satisfy one or more of the above-mentioned desires. Although the present invention may obviate one or more of the above-mentioned desires, it should be understood that some aspects of the invention might not necessarily obviate them.

### BRIEF SUMMARY OF THE DISCLOSURE

The present invention attempts to address this need, as well as other needs and problems associated with existing and previously described magnetic stirring devices. The present magnetic stirring devices include magnetic stirring elements, such as stirrer bars and the like, and magnetic stirring systems, such as stirrer plates and the like. In one contemplated embodiment, the present magnetic stirring devices provide improved stirring efficiency and improved stability of magnetic stirring elements by improving the magnetic field coverage and/or the magnetic field/strength compared to existing magnetic stirring elements/systems. In another embodiment, stirring efficiency is improved by having improved torque in the contemplated stirring plate and/or stirring element. With the improved stability, the present magnetic stirring devices are able to stir or mix compositions comprising two or more different phases more efficiently compared to existing stirring devices, and are able to create greater vortexing of liquid-containing compositions compared to existing stirring devices. As used herein, stirring or mixing can be understood to include dissolving and/or dispersing two or more different phases in a composition. The stability or strength enhancements and vortexing enhancements provided by the present magnetic stirring devices can be related to one or more of the present devices including a magnet with a greater magnetic field coverage compared to existing magnetic stirring devices, including a magnet with a greater magnetic strength compared to existing magnetic stirring devices, or both. More preferably, the enhancement is a function of improved torque in the system. Thus, with the present magnetic stirring devices and methods, the speed and/or stability of mixing multi-phase compositions is enhanced compared to existing magnetic stirring devices.

It can be understood from the present disclosure that the magnets of the present magnetic stirring devices provide enhanced stability of a rotating magnetic stirring element in a multi-phase composition. The enhanced stability enables the magnetic stirring element to spin at higher speeds compared to existing magnetic stirring elements in multi-phase compositions. The higher rotation speeds result in improved vortexing of multi-phase compositions compared to existing magnetic stirring elements. The improved vortexing results in better mixing of the multi-phase compositions. Better mixing can be understood to refer to decreased mixing times and improved quality of the final mixture, such as solution or dispersion.

Multi-phase compositions refer to compositions comprising two or more different liquid phases, two or more different solid phases, combinations of solid and liquid phases, combinations of gas and liquid phases, or combinations of gas and solid phases. With the present stirring devices, the mixing of the composition can include mixing a solid material in a liquid material, a liquid material with a solid material, a first liquid material with a second liquid material, a first liquid material comprising a solid with a second liquid material, a first liquid material with a second liquid material comprising a solid, a first liquid mixture comprising at least two different liquids with a solid, and the like.

In one aspect, the present invention relates to magnetic stirring systems. A magnetic stirring system, as used herein, refers to the devices (e.g., a stir plate) that contains an actuator magnet or actuatable driver magnet and causes rotation of a magnetic stirring element placed above the stirring system, when the magnetic stirring element is located in a beaker of composition comprising two or more phases, such as liquids, solids, gases, and any combinations thereof. Such compositions are referred to herein as multi-phase compositions. Contemplated stirring elements include commercially available stirring elements and the presently described magnetic stirring elements.

The present magnetic stirring systems contain an actuatable driver magnet that rotates about a central axis. The magnetic stirring element also has a magnet that rotates about a central axis. As used herein, “magnetic field coverage angle” is defined as the angle, whose vertex corresponds to the center of rotation, the magnet or magnets occupies/occupy when the magnet or magnets are in a static, non-rotating state. The total magnetic field coverage angle for a system includes angles for both north (N) and south (S) poles. FIG. 28A-C give examples of total magnetic field coverage from 90 degrees to a maximum of 360 degrees.

In one embodiment, a magnetic stirrer system comprises a container-contacting surface for supporting a container comprising a multi-phase composition therein, and at least one actuatable driver magnet spaced apart from the container-contacting surface. The actuatable driver magnet is made up of two half-circular shape magnets. This configuration provides a 360 degree total magnetic field coverage angle as the actuatable driver magnet is in a non-rotating state.

In other embodiments of the magnetic stirrer system, the actuatable driver magnet provides a total magnetic field coverage angle from about 90 degrees to about 360 degrees as the actuatable driver magnet is in a non-rotating state. One example includes a magnet that provides a total magnetic field coverage angle of at least 180 degrees. Another example includes a magnet that provides a total magnetic field coverage angle from about 270 degrees to 360 degrees.

Actuation of the actuator magnet causes rotation of a magnetic stirring element placed in a beaker above the actuator magnet, and present in a multi-phase composition. Therefore, the contemplated magnetic stirring systems can comprise a combination of an actuator magnet providing a total magnetic field coverage angle of 20-360 degrees and a magnetic stirring element. The magnetic stirring element of these embodiments of the present systems may comprise a magnet having a total magnetic field coverage angle of 20-360 degrees in a non-rotating state. Alternatively, these embodiments of the present systems may comprise a conventional magnetic stirring element, such as a magnetic stirring element comprising a coated bar magnet.

In another aspect, the present invention relates to magnetic stirring elements. The magnetic stirring elements, as used herein, refer to the devices that are placed in a container holding a multi-phase composition.

In one embodiment, a magnetic stirring element comprises a magnet and a coating surrounding the magnet. The magnetic stirring element is immersible in a multi-phase composition.

In another embodiment of the magnetic stirrer element, the magnet provides a total magnetic field coverage angle from about 20 degrees to about 360 degrees as the magnet is in a non-rotating state. One example includes a magnet that provides a total magnetic field coverage angle of at least 180 degrees. Another example includes a magnet that provides a total magnetic field coverage angle from about 270 degrees to 360 degrees. The desired result as mentioned above can be made possible by using the novel stirrer element disclosed herein with a conventional stirring plate system.

In yet another aspect, the present invention relates to magnetic stirring methods, using the present magnetic stirring elements and/or magnetic stirring systems.

An embodiment of the present methods comprises providing a magnetic stirring element in a multi-phase composition in a container, and providing the container on a container-contacting surface of a magnetic stirring system. The magnetic stirring element is rotated by actuating an actuatable driver magnet of the magnetic stirring system. In certain embodiments of the present methods, the magnetic stirring element comprises a magnet having a total magnetic field coverage angle of 360 degrees at a non-rotating state. In other embodiments of the present methods, the actuatable driver magnet provides a total magnetic field coverage angle of 360 degrees. And, in further embodiments, each of the magnetic stirring element magnet and the actuatable driver magnet has a total magnetic field coverage angle of 360 degrees at a non-rotating state. And, in still further embodiments, one or both of the actuatable driver magnet and the stirring element magnet provides a total magnetic field coverage angle from about 20 degrees to about 360 degrees, as discussed herein.

The present magnetic stirring devices and methods can be used to mix or stir a variety of different types of multi-phase compositions. For example, the present magnetic stirring devices and methods can effectively mix low viscosity, medium viscosity, and high viscosity liquid-containing compositions. As one non-limiting example, the present devices and methods effectively dissolve carboxymethyl cellulose in water. In other examples, the present devices and methods dissolve other solid materials in water.

In view of the disclosure herein, another embodiment of a magnetic stirring system, which can be different than the embodiment described hereinabove, comprises a container-contacting surface for supporting a container, and at least one actuatable driver magnet spaced apart from the container-contacting surface. The container that can be placed on the container-contacting surface of the magnetic stirring system can comprise a liquid-containing composition located in the container. The actuatable driver magnet is positioned to cause rotation of a magnetic stirring element having a structure that, when the stirring element is located in 500 mL of a 2% carboxymethylcellulose (CMC) aqueous composition in a container in contact with the container-contacting surface and is effective in dissolving 95% of CMC in the 2% CMC aqueous composition in less than 2.5 hours at about 20 degrees C.

Another embodiment of a magnetic stirring element comprises a magnet and a coating surrounding the magnet. The magnetic stirring element is structured, such as sized and shaped to be placed in a container containing a liquid-containing composition. More specifically, the present magnetic stirring element has a structure that, when the stirring element is located in 500 mL of a 2% carboxymethylcellulose (CMC) aqueous composition in a container on a stirring system and is caused to rotate by the stirring system, provides 95% dissolution of CMC in the 2% CMC aqueous composition in less than 2.5 hours at 20 degrees C.

Another embodiment of the present methods comprises providing a magnetic stirring element in a liquid-containing composition in a container, and providing the container on a container-contacting surface of a magnetic stirring system. The magnetic stirring element is rotated by actuating an actuatable driver magnet of the magnetic stirring system. The magnetic stirring element of the present methods has a structure that, when the stirring element is located in 500 mL of a 2% carboxymethylcellulose (CMC) aqueous composition in a container on a stirring system and is caused to rotate by the stirring system, provides 95% dissolution of CMC in the 2% CMC aqueous composition in less than 2.5 hours at about 20 degrees C.

In certain embodiments, the magnetic stirring element is structured to provide 95% dissolution of CMC in less than 10 minutes at about 20 degrees C. In certain embodiments, the dissolution rates provided by the present magnetic stirring elements can be obtained at rotation rates of an actuator magnet of the stirring system greater than about 1000 rotations per minute (RPM). For example, certain embodiments are able to achieve the present dissolution rates when the actuator magnet has a rotation rate from about 1000 RPM to about 1800 RPM.

As used herein, the term “magnetic field distribution” is defined in FIG. 29A-B. Magnetic field distribution is defined in units related to area. “Magnetic field coverage” is described in units of area or percentage of area in relation to a rotational area, throughout the rest of this patent application.

Any feature or combination of features described herein are included within the scope of the present invention provided that the features included in any such combination are not mutually inconsistent as will be apparent from the context, this specification, and the knowledge of one of ordinary skill in the art. In addition, any feature or combination of features may be specifically excluded from any embodiment of the present invention. Additional advantages and aspects of the present invention are apparent in the following drawings, detailed description, and claims.

### BRIEF DESCRIPTION OF THE DRAWING FIGURES

FIG. 1 is a graph of dissolution amount as a function of time. The dissolution percentage can be determined by multiplying the dissolution value by 100. The closed circle represents the dissolution profile for the present magnetic stirring devices. The open circle represents the dissolution profile for a conventional rod-shaped stirring element having a two inch length. The graph illustrates substantially linear dissolution profiles.

FIG. 2 is a graph of dissolution amount as a function of time. The dissolution percentage can be determined by multiplying the dissolution value by 100. The closed circle represents the dissolution profile for the present magnetic stirring devices. The open circle represents the dissolution profile for a conventional rod-shaped stirring element having a two inch length. The graph illustrates substantially sigmoidal dissolution profiles.

FIG. 3 is a perspective view of one embodiment of the present magnetic stirring elements comprising a disk magnet that is magnetized through thickness.

FIG. 4 is an illustration of a top plan view of the disk magnet of the element of FIG. 3.

FIG. 5 is a sectional view along line V-V of FIG. 4. The white portion on the left has south pole on the top end, and north pole on its bottom end; the black portion on the right has north pole on the top end, and south pole on its bottom end.

FIG. 6 is a sectional view of the element of FIG. 3.

FIG. 7 is a perspective view of second embodiment of the present magnetic stirring elements.

FIG. 8 is a perspective view of third embodiment of the present magnetic stirring elements.

FIG. 9 is a perspective view of fourth embodiment of the present magnetic stirring elements.

FIG. 10 is a perspective view of fifth embodiment of the present magnetic stirring elements that comprises a rod magnet.

FIG. 11 is an illustration of a top plan view of a ring magnet of a contemplated magnetic stirring element, magnetized through thickness. More specifically, the ring magnet in this embodiment is made of two separate arcuate shape magnets, each is a “half-ring” magnetized through thickness. The two “half-rings” combine to make a single ring magnet.

FIG. 12 is an illustration of a top plan view of a disk magnet of a contemplated magnetic stirring element, magnetized through thickness.

FIG. 13 is an illustration of a plan view of a rod magnet of a contemplated magnetic stirring element, magnetized through thickness.

FIG. 14 is an illustration of a top see-through perspective view of the stirring element of FIG. 10 illustrating the rod magnet in a cavity.

FIG. 15 is an illustration of a sectional view of a ring magnetic stirring element comprising a ring magnet.

FIG. 16 is an illustration of a plan view of a magnetic stirring element with stabilizing legs.

FIG. 17 is an illustration of a plan view of a magnetic stirring element with stabilizing legs and stirring blades extending from an upper portion of the stirring element base.

FIG. 18 is an illustration of one embodiment of the present magnetic stirring systems.

FIG. 19 is an illustration of an actuatable driver magnet of embodiments of the present magnetic stirring systems.

FIG. 20 is an illustration of a top plan view of the actuatable driver magnet of FIG. 19.

FIG. 21 is an illustration of a vertical sectional view of the actuatable driver magnet of FIG. 19.

FIG. 22 is an illustration of a top plan view of a second embodiment of the present actuatable driver magnets.

FIG. 23 is an illustration of one embodiment of the present magnetic stirring systems in a laboratory.

FIG. 24 is an illustration of one embodiment of the present magnetic stirring systems in a commercial manufacturing system.

FIG. 25A is an illustration of a long conventional stir bar on top of an embodiment of the present magnetic stirring system. This embodiment shows a rectangle shaped bar as a larger conventional stirbar and a new stir plate design which has two half-circle magnets, magnetized through thickness.

FIG. 25B is an illustration of a short conventional stir bar on top of an embodiment of the present magnetic stirring system. This embodiment shows a rectangle shaped bar as a smaller conventional stirbar and a new stir plate design which has two half-circle magnets, magnetized through thickness. When the stir plate spins in the anti-clockwise direction, the magnetic attractive force is continuously along edge A; this explains why smaller stir bar does not spin off easier than the bigger stir bar when using the new stir plate design.

FIG. 25C is an illustration of a conventional long stir bar on top of conventional stirring system. Rectangle (810) shows larger conventional stirbar. Square elements show the conventional stir plates.

FIG. 25D is an illustration of a conventional short stir bar on top of conventional stirring system. Rectangle (820) shows smaller conventional stirbar. Square elements show the conventional stir plates. When the stir plates spin in an anti-clockwise direction, the attraction force “c” between the conventional stir plate and the smaller stir bar (FIG. 25D) is weaker compared to the attractive force “a” between the conventional stir plate and the bigger stir bar (FIG. 25C). As a result, the torque “d” is weaker than the torque “b”. This explains why smaller stir bar spins off easier in the old stir plate design. If the stir plate spins too fast, the stir bar cannot catch up.

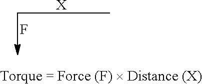

FIG. 25E is an illustration of an embodiment of new stir element having two half-circular shaped magnets, on top of an embodiment of new stirring system having two half-circular shaped magnets. The inner circle shows new stir element which has two half-circular magnets magnetized through thickness. The outer circle shows new stir plate design having two half-circular magnets magnetized through thickness. When the stir plate spins in an anti-clockwise direction, the magnetic attractive force is present continuously along edge A of the stir plate and B of the stir element. This creates the most effective attractive force between the stir plate and the stir element.

FIG. 26 is an illustration of a conventional stir bar on top of another embodiment of driver magnet in the stirring system of the present invention.

FIG. 27A is an illustration of a conventional stir bar on top of a prior art stirring system.

FIG. 27B is an illustration of a conventional stir bar on top of a preferred embodiment of a stirring system in the present invention. This figure illustrates a wide freedom of movement for the stir bar while at rest.

FIG. 28A is an illustration of an embodiment showing a magnetic field coverage of 90°. Magnetic field coverage is Angle (N)+Angle (S)=45°+45°=90°.

FIG. 28B is an illustration of an embodiment showing a magnetic field coverage of 180°. Magnetic field coverage is Angle (N)+Angle (S)=90°+90°=180°.

FIG. 28C is an illustration of an embodiment showing a magnetic field coverage of 360°. Magnetic field coverage is Angle (N)+Angle (S)=180°+180°=360°.

FIG. 29A is an illustration of an embodiment showing a conventional stirring system (showing comparison of magnetic field distribution in units related to area).
Rotational area=πr²=(3.14) (3 in)²˜28 in²
Magnet area (N)=1 in×1 in=1 in²
Ratio of magnet area to rotational area=1/28
Magnetic field distribution=1/28=0.04

FIG. 29B is an illustration of an embodiment showing a stirring system (embodiment of the present invention).
Rotational area=πr²=(3.14) (3 in)²˜28 in²
Magnet area (N)=28 in²/2=14 in²
Ratio of magnet area to rotational area=14/28=1/2
Magnetic field distribution=1/2=0.5
   Magnetic field distribution of this embodiment is ˜13 times (0.5/0.04) greater than the conventional stirring system.

FIG. 30 is an illustration of various driver magnets consisting of disk magnets and ring magnets.

FIG. 31 is an illustration of magnetic stirring element bases.

FIG. 33A is an illustration of an embodiment of a magnet where arrow shows magnetism through thickness and perpendicular to the plane of the disc.

FIG. 33B is an illustration of an embodiment of a magnet where arrow shows magnetism through thickness.

FIG. 33C is an illustration of another embodiment of a magnet where arrow shows magnetism through thickness.

FIG. 33D is an illustration of an embodiment of a magnet where arrows represent magnetic field and magnetism through thickness.

FIG. 33E is an illustration of an embodiment of a disc/circular magnet showing magnet in stirring element and magnetism through thickness.

FIG. 34A is an illustration of a side view of a circular magnet with two poles and one face where magnetism is through diameters.

FIG. 34B is an illustration of a perspective view of the magnet of FIG. 34A.

### DETAILED DESCRIPTION OF THE DISCLOSURE

The size of the magnet, the shape of the magnet, the orientation of the poles, and the size of the housing can influence the magnetic field coverage of the magnetic stirring element and contribute to poor vortexing or mixing of liquid containing compositions, especially compositions with medium to high viscosities. A traditional stirring element having a magnetic bar in the housing only covers a horizontal line magnetic field, such that, the bar magnet has a direction of magnetism parallel to its length. The stirring or rotation of the stirring element, and the stirring stability of the stirring element, depends upon the rotation speed of the actuatable magnet of the stirrer plate.

The spinning out associated with existing magnetic stirring devices may be due to the torque in the magnetic field, area of field distribution, a total magnetic field coverage angle of the stirring element, the total magnetic field coverage angle of the actuator magnet, the speed at which the actuator magnet of a stirrer plate rotates, the relative ratio of magnetic strengths between the magnetic stirring element and the actuator magnet, or a combination of the above factors.

The present magnetic stirring devices include magnetic stirring elements and magnetic stirring systems. With the present magnetic stirring devices, improvements in mixing stability of multi-phase compositions can be obtained compared to existing magnetic stirring devices. For example, with the present magnetic stirring devices, improvements in the stability of magnetic stirring elements can be obtained, and improvements in vortexing of the liquid-containing compositions can be obtained compared to existing magnetic stirring devices. The present magnetic stirring devices and methods provide relatively quick mixing/dispersion of solutes in solvents and/or mixing of low, medium, and high viscosity solutions or suspensions. In view of the following description, it can be appreciated that the present magnetic stirring devices provide an increase in mixing/dispersing efficiency, an increase in dissolving efficiency, an increase in stability of the magnetic stirring elements, a higher mixing speed in a stable condition without or with much less spin-out problems compared to traditional devices, a reduction in “spinning-out” of the magnetic stirring element, an increase in turbulence of a liquid-containing composition, an increase in shearing of the liquid-containing composition, an increase in vortexing caused by rotation of the magnetic stirring element, an increased dispersion of materials in the liquid-containing composition, a reduced mixing time, a reduced dissolving time, a reduced dispersion time, and combinations thereof.

As used herein, a magnetic stirring element refers to a device that is structured, such as sized and shaped, to be placed in a container holding a liquid-containing composition. The magnet inside of the stirring elements disclosed herein may be a bar magnet, even though the coating of the magnetic stirring elements may not be bar shaped. As discussed herein, the present magnetic stirring elements can have a variety of physical features and configurations to provide the improvements in mixing, dissolving, or dispersing of liquid-containing compositions.

As used herein, the term “ring magnet” refers to a ring-shaped magnet made of two separate arcuate shape magnets, each is a “half-ring” magnetized through thickness. The two “half-rings” combine to make a single ring magnet. As a result, the single ring magnet is magnetized through thickness, and the two half-rings are arranged such that the orientations of magnetism in the two the half-ring are opposite from each other. In other words, when looking at the ring-shaped face of the single ring, one half of the ring is north pole, the other half is south pole. A “ring magnet” as used herein is not intended to refer to a ring magnet that is magnetized through diameter, unless specifically provided otherwise.

As used herein, the term “disk magnet” refers to a disk-shaped magnet made of two separate half-disk/half circular-shaped magnets, each is magnetized through thickness. The two “half-disks” combine to make a single disk magnet. As a result, the single disk magnet is magnetized through thickness, and the two half-disks are arranged such that the orientations of magnetism in the two the half-disks are opposite from each other. In other words, when looking at the circular face of the single disk, one half of the disk is north pole, the other half is south pole. A “disk magnet” as used herein is not intended to refer to a disk magnet that is magnetized through diameter (e.g., 2 poles−1 face as shown at bottom of FIG. 34A), unless specifically provided otherwise.

A magnetic stirring system, as used herein, refers to a device that contains an actuator magnet and causes rotation of a magnetic stirring element, including the presently described magnetic stirring elements, when the magnetic stirring element is located in a liquid-containing composition. A magnetic stirring system can be a stand alone device, and can include a housing containing an actuatable driver magnet, or a magnetic stirring system can be a component of a manufacturing system, as discussed herein. In addition, the magnetic stirring system can include one station or more than one station, such as 2, 4, 6, or 8 stations that allow stirring/mixing of compositions present in 2, 4, 6, or 8 vessels, respectively. The magnetic stirring system can be provided as a component of a laboratory system, a pilot scale-up facility, or a commercial production facility.

A liquid-containing composition, as used herein, refers to any composition that comprises a liquid. When a composition comprises water, such a composition can be referred to as an aqueous composition. Liquid-containing compositions also include compositions that include liquids other than water. For example, certain liquid-containing compositions can include a liquid component that is only an organic material, such as an organic solvent. Or, the liquid-containing compositions can include a liquid component that is an oil. The present liquid-containing compositions include liquids, such as compositions with very little viscosity, as well as more viscous materials, such as gels and the like. For example, when a liquid-containing composition is referred to herein, the composition can have a viscosity from about 0 centipoise (cps) to about 3000 cps. As one example, a glycerol-based composition may have a viscosity less than or equal to about 1500 cps. As another example, a 2% carboxymethylcellulose (CMC) aqueous solution may be understood to have a medium viscosity from about 400 cps to about 800 cps. Alternatively, liquid-containing compositions may have a viscosity greater than 3000 cps. Liquid-containing compositions can be solutions, suspensions, emulsions, and the like. In addition, the liquid-containing compositions can include combinations of different liquids, including liquids having different specific gravities, liquids having different hydrophilic or hydrophobic properties, and the like, for example.

Reference will now be made in detail to the presently illustrated embodiments of the invention. Wherever possible, the same or similar reference numbers are used in the drawings and the description to refer to the same or like parts. It should be noted that the drawings are in simplified form and are not to precise scale. In reference to the disclosure herein, for purposes of convenience and clarity only, directional terms, such as, top, bottom, left, right, up, down, over, above, below, beneath, rear, front, distal, and proximal are used with respect to the accompanying drawings. Such directional terms should not be construed to limit the scope of the invention in any manner.

Although the disclosure herein refers to certain illustrated embodiments, it is to be understood that these embodiments are presented by way of example and not by way of limitation. The intent of the following detailed description, although discussing exemplary embodiments, is to be construed to cover all modifications, alternatives, and equivalents of the embodiments as may fall within the spirit and scope of the invention as defined by the appended claims.

One aspect of the present invention relates to magnetic stirring systems. For example, an embodiment of a magnetic stirring system comprises a housing, a container-contacting surface coupled to the housing for supporting a container comprising a multi-phase composition therein; and at least one actuatable driver magnet disposed in the housing, and the driver magnet is positioned below and spaced apart from the container-contacting surface. The at least one driver magnet rotates about a vertical rotational axis. In one embodiment, the actuatable driver magnet provides a 360 degree total magnetic field coverage angle at rest.

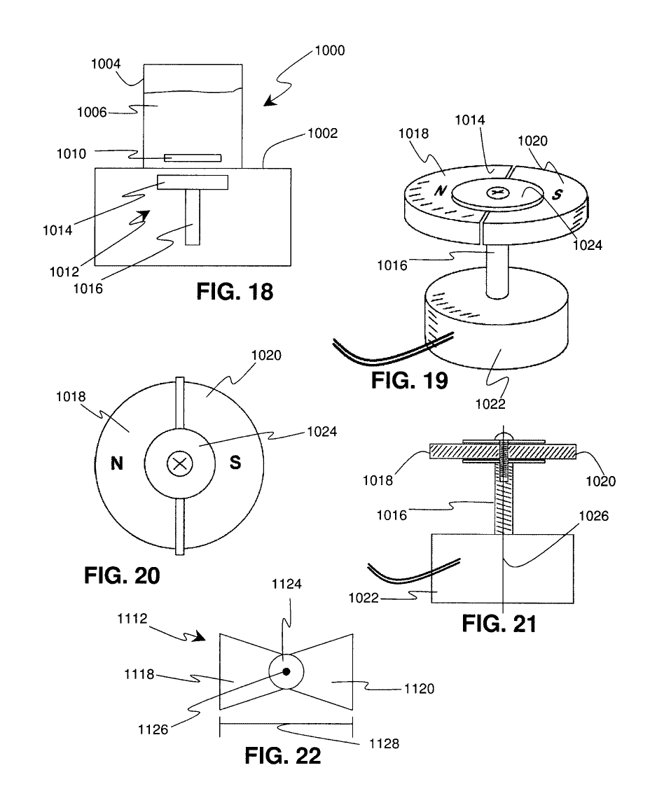

For example, as shown in FIG. 18, a magnetic stirring system 1000 comprises a container-contacting surface 1002. The container-contacting surface 1002 supports a container 1004 comprising a multi-phase composition 1006. A magnetic stirring element 1010 is illustrated as being located in composition 1006 (the magnetic stirring element 1010 is shown being spaced apart from the bottom of the container 1004. In actuality, the stirring element 1010 can or cannot levitate off the bottom of the container. Some embodiments of the stirring element may be more capable of achieving levitation than other embodiments, while maintaining spinning stability). The magnetic stirring system 1000 comprises at least one actuatable driver magnet 1012 (preferred embodiment is magnetized through thickness, although other directions of magnetization is also possible) that is spaced apart from the container-contacting surface 1002.

The actuatable driver magnet 1012 can comprise any suitable magnetic material in any shape and size so long as it achieves the specific properties as disclosed herein. In certain embodiments, the actuatable driver magnet is a neodymium magnet.

For example, the present magnetic stirrer systems can comprise an actuatable driver magnet selected from the group consisting of disk magnets and ring magnets. As shown in FIGS. 18-21, the actuatable driver magnet 1012 is a ring magnet 1014 magnetized through thickness. The ring magnet 1014 is operably coupled, either directly or indirectly, to a motor 1022 or other drive mechanism by a connector 1016. The ring magnet 1014 consists of a semi-annular piece with north pole portion 1018 facing upwards (having a direction of magnetism parallel line 1026) and a semi-annular piece with south pole portion 1020 facing upwards (having a direction of magnetism parallel line 1026). The ring magnet 1014 is coupled to the connector 1016 by an attachment element 1024. The axis of rotation 1026 of this actuatable driver magnet 1012 is shown in FIG. 21.

Particularly stable configurations are obtained with circular actuatable driver magnets and circular magnets provided in magnetic stirring elements. Additional examples of the actuatable driver magnet for magnetic stirrer systems and magnets of the stirring elements are illustrated in FIG. 30. In certain embodiments, as described herein, either the actuatable driver magnet, the stirring element magnet, or both, provide a total magnetic field coverage angle from about 20 degrees to about 360 degrees at rest, or about 25 degrees to 360 degrees, about 45 degrees to 360 degrees, about 75 degrees to 360 degrees, about 90 degrees to 360 degrees, about 100 degrees to 360 degrees, about 150 degrees to 360 degrees, about 200 degrees to 360 degrees, about 230 degrees to 360 degrees, or most preferably, about 270 degrees to 360 degrees.

Thus, embodiments of the present systems may comprise a plurality of the actuatable driver magnets.

There are other ways to describe the contemplated arrangements of driver magnet and arrangement of magnets in contemplated stirring elements. One way is to through comparing magnetic field distribution in relation to area. For example, a driver magnet has terminal ends, or peripheral edges, such that during rotation, these terminal ends define the outer periphery of an imaginary circle (see 1800 in FIG. 4, or see 800 in FIG. 29A, note that both examples in FIG. 29A-B having magnets that are magnetized through thickness) on the container-contacting surface, and this imaginary rotational circle 800 shares the vertical rotation axis of the driver magnet as its center, and the circle 800 comprises an area, a radius, and a diameter. It should be noted that the term “imaginary rotational circle” is also used elsewhere in the current application when discussing stirring elements. Similarly, the magnet inside of stirring element also creates an “imaginary rotational circle” that may or may not be of the same size as the “imaginary rotational circle” created by corresponding driver magnets. Therefore, the term imaginary rotational circle shall be read in the context of the descriptions surrounding the term. Next, contemplated driver magnets in the preferred embodiments are arranged such that the magnets have a direction of magnetism that parallels the rotation axis of the driver magnet. For example, one contemplated embodiment uses two half-circular shaped magnets to form a complete circular disk driver magnet. These two magnets are magnetized through thickness, thereby having a direction of magnetism that parallels the rotation axis. In other words, these magnets have a north pole-to-south pole orientation substantially parallel to the vertical rotation axis. This way, when the driver magnet is at rest, not rotating, and not affected by other magnets outside of the housing, the driver magnets produce a magnetic field having field lines penetrating through at least part of the imaginary rotation circle 800 in a direction substantially perpendicular to a plane of the rotation circle 800. The ratio of the area of rotation circle 800 penetrated by field lines in a direction substantially perpendicular to the plane, to the entire circular area of the imaginary rotation circle 800, is defined as magnetic field distribution (see examples in FIG. 29A-B). The area of rotation circle 800 penetrated by field lines in a direction substantially perpendicular to the plane is hereinafter referred to as “magnetic field coverage area.” The area of rotation circle not penetrated by field lines in a direction substantially perpendicular to the plane is defined as void space.

For example, a driver magnet can have two half-circular magnets. The two half-circular magnets form a disk-shaped configuration. Both of the half-disk magnets are magnetized through thickness. One has north pole facing upwards, the other has north pole facing downwards. Because these two magnets are magnetized through thickness, the bulk of their magnetic field lines can be illustrated as being substantially vertical, or substantially parallel to the vertical rotation axis. One of ordinary skill in the art will immediately recognize, that, in such magnets, their field lines emanating out of their peripheral region will naturally curve and wrap around towards the nearest opposite pole, and thus not substantially straight and vertical.

Thus, other embodiments of the inventive subject matter can be distinguished by their perspective magnetic field distribution.

In one contemplated embodiment, wherein the magnetic field distribution is equal to or more than 15%. In another embodiment, the magnetic field distribution is equal to or more than 20%. Yet in another embodiment the magnetic field distribution is equal to or more than 30%. Preferably, the magnetic field distribution is equal to or more than 50%, or more preferably, 80%, or even more preferably, equal to or about 100%.

Contemplated driver magnet can have shapes and configurations illustrated in FIG. 30. In other embodiments, FIG. 30 refers to the shape and configuration of magnetic field coverage areas. One skilled in the art will immediate recognize, that although in general the shape of the magnet and shape of the magnetic field coverage area should correspond to each other, there can be other ways to produce the same shapes of magnetic field coverage area without using corresponding shapes of magnets. Those variations are specifically contemplated in this application.

The concept of magnetic field distribution can also be used to describe the stirring elements of the instant invention.

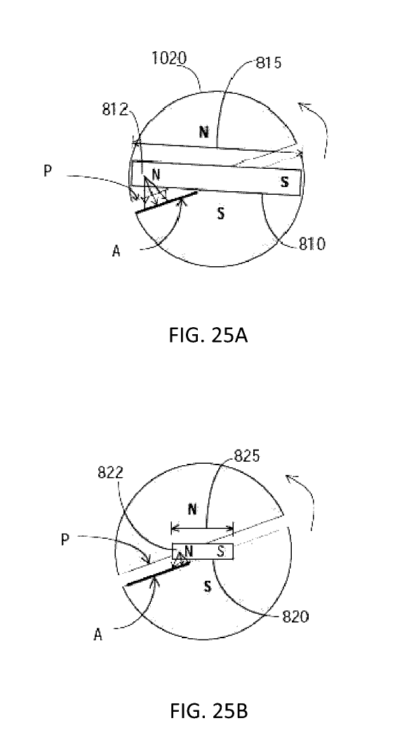

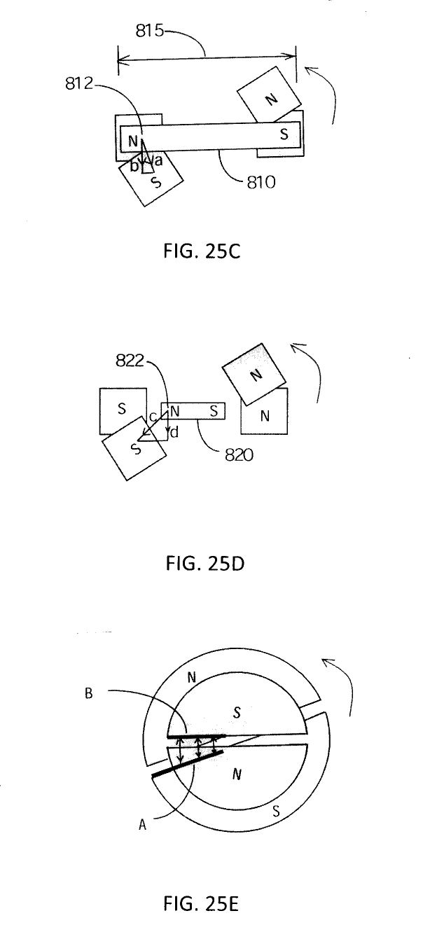

Another way to describe contemplated arrangements of driver magnet is by describing the differences in torque the driver magnet has on different sizes of stirring elements. Likewise, another way to describe contemplated arrangements of magnets in contemplated stirring element is by describing the differences in torque the magnet in the stirring element has on different sizes of driver magnets. Before discussing torque, it should be noted that contemplated magnetic field coverage area lies between the center and the periphery of the imaginary rotation circle. Because of that, the magnetic field coverage area overlaps a distance that may be part, or all, of the radius of the imaginary rotation circle. For example, a pie-shaped driver magnet (magnetized through thickness) overlapping an entire quarter region of an imaginary rotation circle has a magnetic field coverage area that overlaps the entire radius of the imaginary rotation circle. In another example, a ring-shaped driver magnet (magnetized through thickness) with a void space in the middle creates a magnetic field coverage area that does not overlap the entire distance of the radius, but overlaps only a percentage of the radius. Based on the overlapping coverage, different torque can be achieved. In other embodiments, differences in torque can also depend on the lengths of a straight “propelling edge” (P) or straight “attractive edge” (A) of the driver magnet (see FIGS. 25A, 25B). The propelling edge (P) propelling the same pole of a stir bar, while the attractive edge (A) attracts terminal end of the stir bar that has the opposite pole as the attractive edge (A).

Referring now to FIGS. 25A-25E; comparison in torque created by the embodiments of the instant invention can be made by using the same driver magnet to drive different sizes of conventional rod-magnet stir bar. First, when the driver magnet 1020 rotates to drive a rather long rod-magnet stir bar 810 into rotation in the container, the rotation of the long stirring bar 810 has a first diameter 815, and wherein the magnetic field of the driver magnet 1020 is capable of applying an amount of torque onto a terminal end 812 of the long stirring bar 810 during rotation that is substantially the same amount of torque the magnetic field applies to a terminal end 822 of a relatively shorter stirring bar 820, wherein a rotation of the short stir bar 820 has a second diameter 825 that is between and including 40%-95% of the first diameter 815; more preferably, between and including 50%-90%; even more preferably, between and including 50%-75%. The consistency in torque is made possible because by having half-circular disk magnets (magnetized through thickness) as shown in FIG. 25, their attractive edges span across the entire diameter of the imaginary circle 800. The long attractive edge provides the same distance between the terminal end of a stir bar to the closest point of the attractive edge, whether it's a long stir bar 810, or a short stir bar 820. Because torque is distance times force (T=D*F), since the distance between the terminal ends of stir bars 810 and 820 to the closest point of the attractive edge (A) is the same, the torque of the contemplated stirring system remains consistent between various sizes of stirring elements. Similarly, the long propelling edge (P) provides the same distance between a terminal end of a stir bar to the closest point of the propelling edge (P), whether it's a long stir bar 810, or a short stir bar 820. Since the distance between the terminal ends of stir bars 810 and 820 to the closest point of the propelling edge (P) is the same, the torque of the contemplated stirring system remains consistent between various sizes of stirring elements.

Referring to FIG. 25E, the inner circle represents an embodiment of the contemplated stirring element having two half-disk magnets, each magnetized through thickness. The outer circle is a driving magnet of an embodiment of the contemplated stirring system positioned below the stirring element, and using two half-disk magnets, each magnetized through thickness. Here, attractive edge A of the driver magnet below attracts edge B of stirring element above. It should be noted that edge B has a polarity of north, because it is the underside of the half-disk inner circle marked “S.”

In addition, the contemplated long attractive edge (A)/propelling edge (P) improve stability by providing a relatively more areas to attract/propel a stir element, and thereby increase torque. A stirring element is much less likely to spin off because the contemplated attractive edge/propelling edge provide more points (along the diameter of the circle 800) to attract/propel the stirring element.

In preferred embodiments, the magnetic field coverage area overlaps the radius of the imaginary rotation circle by 40-100%, more preferably, by 75-100%, even more preferably, 85%-100%, and most preferably, equal to or about 100%.

In other preferred embodiments, contemplated magnet (magnetized through thickness, either as a driver magnet or as the magnet in stirring element) has a straight or generally straight attractive edge (A) running from the center of the imaginary rotation circle to the periphery of the imaginary circle, and the attractive edge (A) has a length that is equal to or more than 35% of the radius of the imaginary rotation circle; or preferably, equal to or more than 40% of the radius of the imaginary rotation circle; or more preferably, equal to or more than 50% of the radius of the imaginary rotation circle; or still more preferably, equal to or more than 60% of the radius of the imaginary rotation circle; or even more preferably, equal to or more than 75% of the radius of the imaginary rotation circle; or still even more preferably, equal to or more than 85% of the radius of the imaginary rotation circle; or most preferably, equal to about 100% of the radius of the imaginary rotation circle.

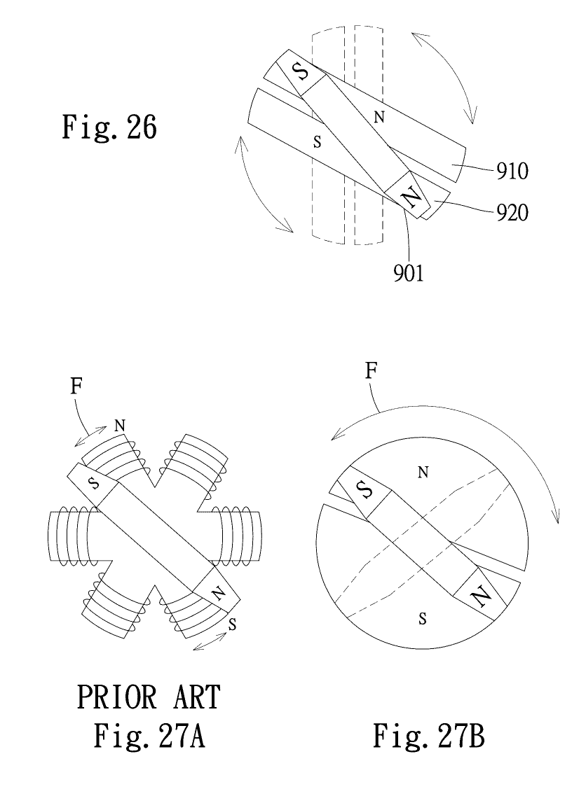

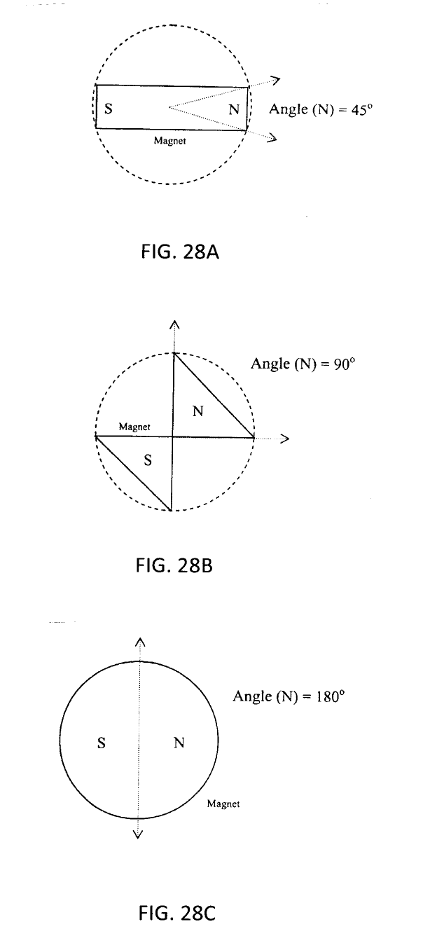

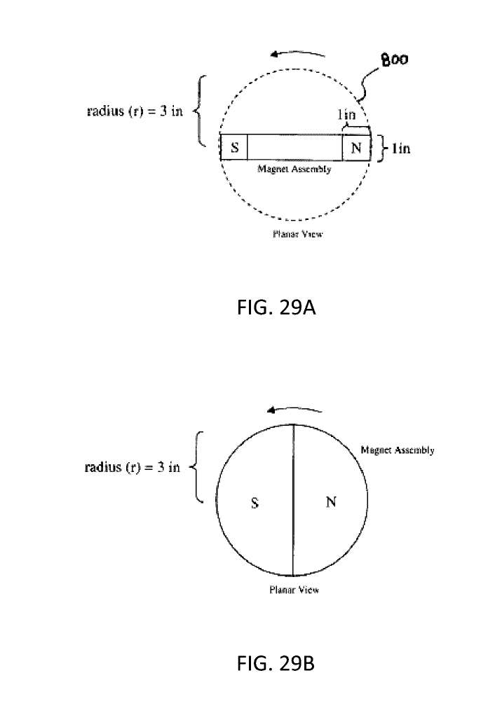

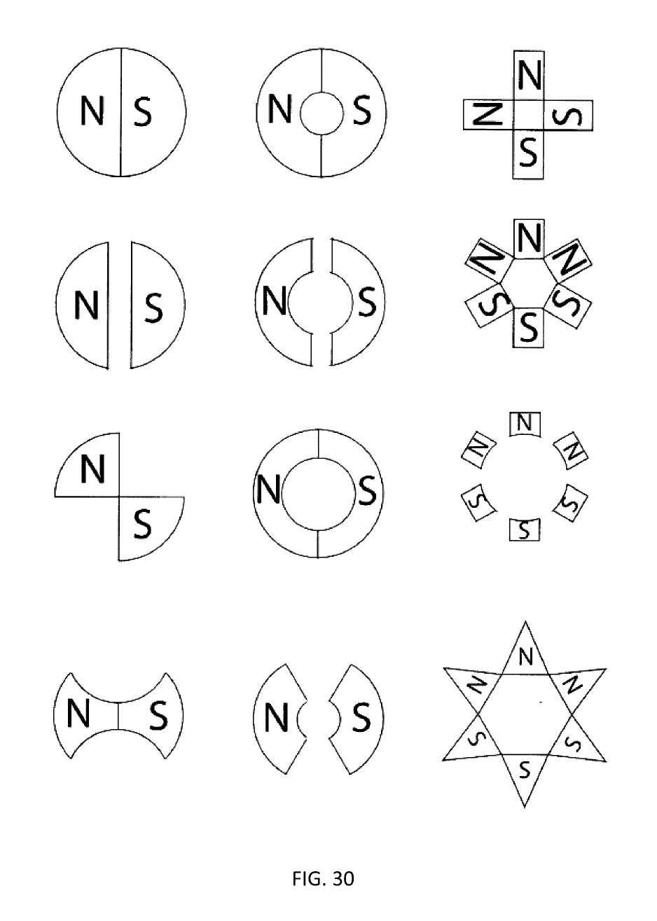

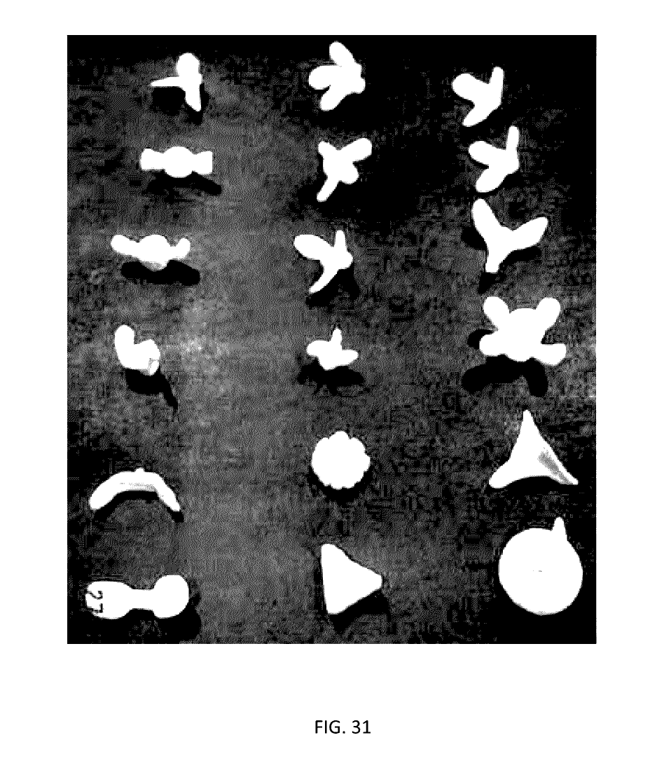

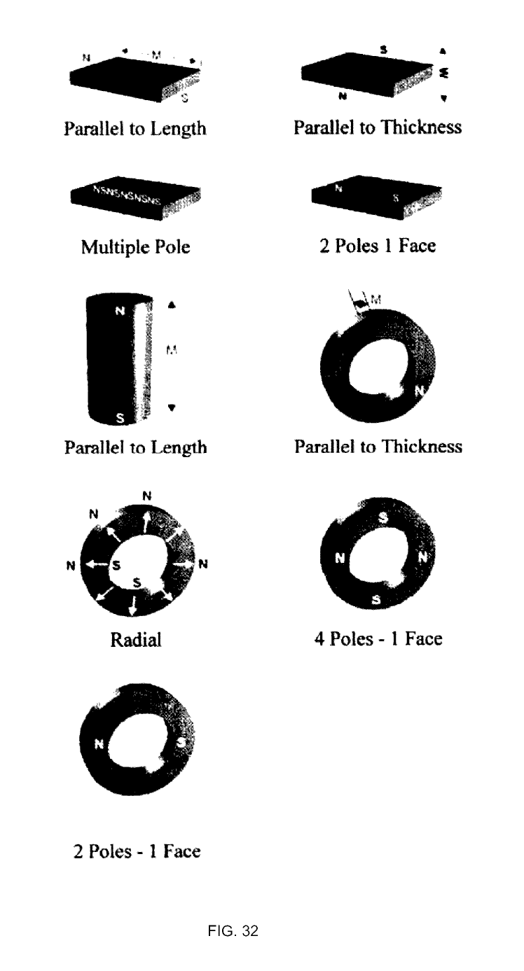

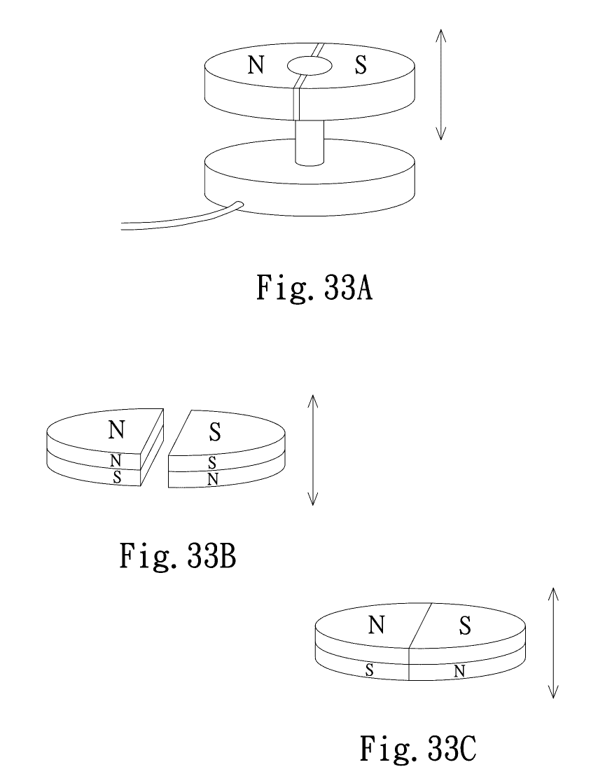

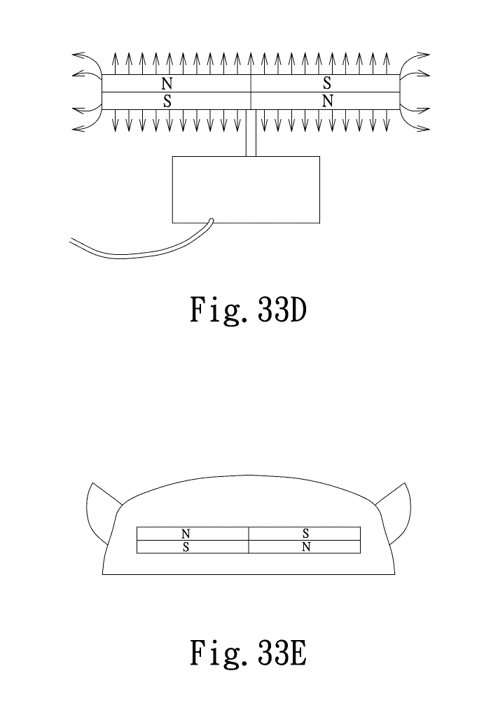

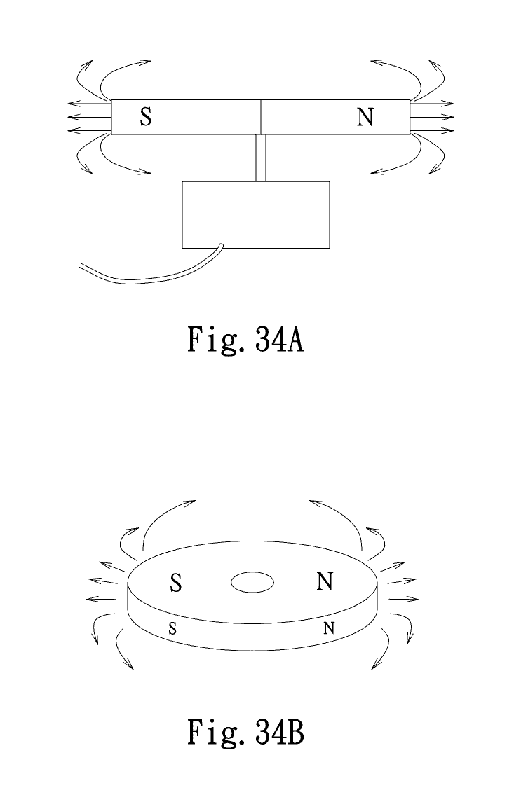

FIG. 26 shows one embodiment of the stirring system having two bar driver magnets 910 and 920. Both are magnetized through thickness, bar 910 has north pole facing towards conventional stir bar 901. Bar 920 has south pole facing towards conventional stir bar 901. These two bar magnets 910 and 920 provide attractive edge (A) and propelling edge (P) equal to 100% of the radium of the imaginary rotation circle.

Similarly in yet other preferred embodiments, contemplated magnet (magnetized through thickness, either as a driver magnet or as the magnet in stirring element) has a straight or generally straight propelling edge (P) running from the center of the imaginary rotation circle to the periphery of the imaginary circle, and the propelling edge (P) has a length that is equal to or more than 35% of the radius of the imaginary rotation circle; or preferably, equal to or more than 40% of the radius of the imaginary rotation circle; or more preferably, equal to or more than 50% of the radius of the imaginary rotation circle; or still more preferably, equal to or more than 60% of the radius of the imaginary rotation circle; or even more preferably, equal to or more than 75% of the radius of the imaginary rotation circle; or still even more preferably, equal to or more than 85% of the radius of the imaginary rotation circle; or most preferably, equal to about 100% of the radius of the imaginary rotation circle.

The present systems may also comprise at least one motor operably coupled to the actuatable driver magnet to cause rotation of the actuatable driver magnet about the vertical rotation axis.

The present systems may comprise one or more magnetic stirring elements, as described herein. The magnetic stirring elements are structured, such as sized and shaped for placement in a container comprising a multi-phase composition. In certain combinations, the magnetic stirring element is a rod magnet, and the actuatable driver magnet is selected from the group consisting of disk magnets (magnetized through thickness) and ring magnets (magnetized through thickness). In other combinations, the magnetic stirring element comprises a disk magnet (magnetized through thickness) or a ring magnet (magnetized through thickness), and the actuatable driver magnet is selected from the group consisting of disk magnets (magnetized through thickness) and ring magnets (magnetized through thickness). Some of the present systems may comprise a magnetic stirring element which comprises a stirring element base comprising a magnet and a plurality of stirring blades extending from the stirring element base.

The actuatable driver magnet can be a unitary member or a multi-piece member. In certain embodiments, the actuatable driver magnet consists of a plurality of pieces coupled together.

The actuatable driver magnet of the present systems may comprise a first surface and an opposing second surface, at least one of the first surface and the second surface comprising at least one north pole portion and at least one south pole portion.

Another aspect of the present invention relates to magnetic stirring elements. For example, the preferred embodiments of the magnetic stirring element comprise a top, a base, and a vertical rotation axis. Preferred embodiments also may have at least one magnet having a direction of magnetization, and the at least one magnet is disposed in the stirring element such that the direction of magnetization is substantially parallel to the vertical spinning axis. Also contemplated is for the stirring element to have a coating surrounding the magnet. In certain embodiments, the magnetic stirring element is immersible in a multi-phase composition and the magnet provides a 360 degree magnetic field coverage at rest.

Further contemplated embodiments provides that the at least one magnet has terminal ends distal from the vertical rotation axis such that during rotation, the terminal ends define the periphery of an imaginary rotation circle (see 1800 in FIG. 4), and the rotational circle 1800 having the vertical rotation axis as its center, and the circle 1800 comprises an area, a radius, and a diameter. For example, an embodiment can have a bar magnet disposed horizontally within the stirring element. The terminal ends of the bar magnet would define the periphery of an imaginary rotation circle when the stirring element rotates. The center point on the bar magnet equal-distant to both terminal ends of the magnet would be where the vertical rotation axis is, and the length of the bar magnet would equal to the diameter of the imaginary rotation circle.

Other contemplated embodiments of the current invention provides that when the at least one magnet is at rest and not rotating, and not affected by other magnets outside or near the stirring element, produces a magnetic field having field lines penetrating through at least part of the imaginary rotation circle in a direction substantially perpendicular to the plane of the rotation circle. For example, as illustrated in FIG. 4, a stirring element can have two half-circular magnets (N, S) embedded within. The two half-circular magnets form a disk-shaped configuration. Both of the half-disk magnets are magnetized through thickness. One has north pole facing upwards, the other has north pole facing downwards. Because these two magnets are magnetized through thickness, the bulk of their magnetic field lines can be illustrated as being substantially vertical, or substantially parallel to the vertical rotation axis. One of ordinary skill in the art will immediately recognize, that, in such magnets, their field lines around the periphery will naturally curve and wrap around towards the nearest opposite pole, and thus not substantially straight and vertical. One skilled in the art will also recognize, that the arrangement and configuration of contemplated magnets in stirring elements (in terms of magnetic field coverage area, magnetic field distribution, torque, and all other properties) can be similar to that described earlier regarding driver magnets. As such, above discussions regarding driver magnet is specifically incorporated herein to describe magnets for contemplated stirring element. All discussions regarding magnets for contemplated stirring element are also specifically incorporated to describe driver magnets.

Overall, contemplated magnets will have vertical field lines that pass through the imaginary rotation circle 1800 of the stirring element. The area of imaginary rotation circle penetrated by these vertical field lines in a direction substantially perpendicular to the plane of the circle is herein defined as the magnetic field coverage area. In the example of a disk-shaped magnet, the magnetic field coverage area is as same, or substantially the same, as the area of the circular side of the disk-magnet. And since the disk-magnet also defines the area of the imaginary rotation circle in this particular embodiment, the coverage is at 100% or nearly 100%. It should be noted that it may not be a complete 100% coverage because field lines at the periphery tend to curve towards the nearest opposite pole, as discussed above.

In some preferred embodiments, the magnetic field coverage area is equal to or more than 15% of the rotation circle area; more preferably, equal to or more than 20% of the rotation circle area; even more preferably, equal to or more than 30% of the rotation circle area; still more preferably, equal to or more than 50% of the rotation circle area; further preferably, equal to or more than 80% of the rotation circle area; most preferably, equal or substantially equal to 100%.

In other embodiments, the magnet provides a total magnetic field coverage angle from about 90 degrees to about 360 degrees as it rotates about a vertical rotation axis. One example of a magnet has a total magnetic field coverage angle of at least 180 degrees. Another example of a stirring element magnet may have a total magnetic field coverage angle from about 270 to 360 degrees.

In certain embodiments, the magnet of the stirring element is selected from the group consisting of disk magnets, ring magnets, rod/bar magnets. The magnets can have a variety of geometric shapes, including circular disks and rings, non-circular curved discs and rings, polygonal disks and rings, and the like. Contemplated magnet configurations and shapes can also include any of the configurations and shapes described else where in this application for the actuatable driver magnet of the magnetic stirring system. Contemplated magnets are most preferred to be magnetized through thickness.

The magnet can be provided as a component of a stirring element base, and the stirring element base can be selected from the group consisting of circular bases and polygonal bases. The stirring element may comprise a plurality of stirring blades extending from the stirring element base. The stirring element base may comprise a container-facing surface selected from the group consisting of planar surfaces; concave surfaces; convex surfaces, and combinations thereof. In certain embodiments, the stirring element base comprises a convex container-facing surface.

Some embodiments of the present stirring elements comprise a stirring element base that has an upper portion and a lower portion, and a first portion of the plurality of stirring blades extends from the upper portion and a second portion of the plurality of stirring blades extends from the lower portion.

Some embodiments of the present stirring elements comprise a stirring element base that comprises only one sidewall, and a bottom surface, and each of the plurality of stirring blades comprises a distal end located the same distance from the bottom surface.

Some of the present elements comprise a plurality of stabilizing legs extending from a lower portion of the stirring element base.

Some embodiments of the present stirring elements comprise a stirring element base that comprises a lower portion and an upper portion, and the plurality of stirring blades extend from the upper portion of stirring element base.

Some embodiments of the present stirring elements comprise a stirring element base that comprises at least one void.

Some embodiments of the present stirring elements comprise a stirring element base that has a vertical rotation axis, and each of the plurality of stirring blades is oriented from about a 0 degree angle relative to the vertical rotation axis to about an 80 degree angle relative to the vertical rotation axis.

Some embodiments of the present stirring elements comprise a stirring element base that has a lateral surface having a surface area no less than 10 mm².

Another aspect of the present invention relates to magnetic stirring elements, including but not limited to the stirring elements described above. For example, an embodiment of a magnetic stirring element comprises a magnet, and a coating surrounding the magnet. The magnetic stirring element is structured, such as sized and shaped, to be placed in a container suitable for containing a liquid-containing composition. These magnetic stirring elements have an increased magnetic field coverage relative to existing magnetic stirring elements.

Examples of containers in which the magnetic stirring elements can be located include beakers, flasks, jars, test tubes, vials, centrifuge tubes, microplates, sealed containers, open containers, sterilized containers, and the like. The containers can have any desirable volume range from microliters to liters or more. The present magnetic stirring elements are sized for the particular container in which the stirring element is to be placed.

In this aspect, the present magnetic stirring element has a structure that, when the stirring element is located in 500 mL of a 2% CMC aqueous composition in a container on a stirring system and is caused to rotate by the stirring system, provides 99% dissolution of CMC in the 2% CMC aqueous composition in less than 2.5 hours at about 20 degrees C. (e.g., room temperature).

The magnet of the present magnetic stirring elements can comprise any suitable and/or conventional magnetic material. In certain embodiments, including the illustrated embodiments, the magnets comprise neodymium, and can be understood to be neodymium magnets. In more detail, the present magnets can comprise a material represented by the following formulas Nd₂Fe₁₄B or NdFeB. In certain embodiments, the magnets comprise samarium cobalt, and can be understood to be samarium cobalt magnets. In certain embodiments, the magnets comprise aluminum, nickel, and cobalt, and can be understood to be Alnico magnets. Certain magnets comprise stainless steel. The magnets of the present magnetic stirring elements can have a magnetic strength of up to 48 Mega Gauss Oersteds (MGOs), or more. For example, the magnets can have a magnetic strength of 42 MGOs, 45 MGOs, 46 MGOs, or 47 MGOs. The present magnets can be understood to provide a magnetic field strength of up to about 15,000 Gauss. For example, a 42 MGO rated magnet can have a magnetic field strength of about 13,000 Gauss. Examples of magnets useful in the present magnetic stirring elements can be obtained from companies, such as Magnet City (Miami, Fla.) and V&P Scientific, Inc. (San Diego, Calif.).

The magnets of the present stirring elements may comprise one component having two or more magnetic poles, or may comprise two or more components assembled together to form the magnet having two or more magnetic poles. The present magnets have at least two poles on one face or surface of the magnet. This is in contrast to magnets that may have two opposing surfaces, each surface having only a single pole, such as might be associated with tumble magnets. For example, an embodiment of the magnets of the present stirring elements may be a unitary or single element having one north pole and one opposing south pole on the same surface. Another embodiment of the magnets may be a two piece element coupled together such that the resulting assembly has one north pole and one opposing south pole on the same surface of the assembly. Additional embodiments may include more than two pieces, for example three equal pieces, four pieces, or more.

In certain embodiments, the magnets of the present stirring elements are magnetized through the thickness of the magnet.

The coating of the present magnetic stirring elements can comprise any suitable material, including conventional materials. The coating is typically chemically inert with the components of the liquid-containing composition. The coating is effective in preventing the magnetic stirring element from corroding, even in the presence of sodium chloride, acetic acid, citric acid, ammonia, hydrogen peroxide, and sodium hypochlorite. The coating of the present stirring elements do not react with organic solvents, such as dimethyl sulfoxide, ethanol, isopropyl alcohol, and the like. The coating of the present stirring elements should also be non-toxic to microorganisms. Examples of suitable coating materials of the present magnetic stirring elements include polymer films and the like, such as parylene and polytetrafluoroethylene (PTFE) or TEFLON®.

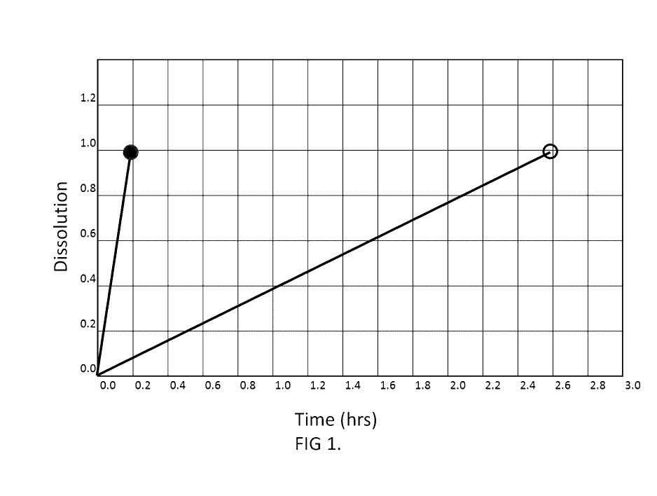

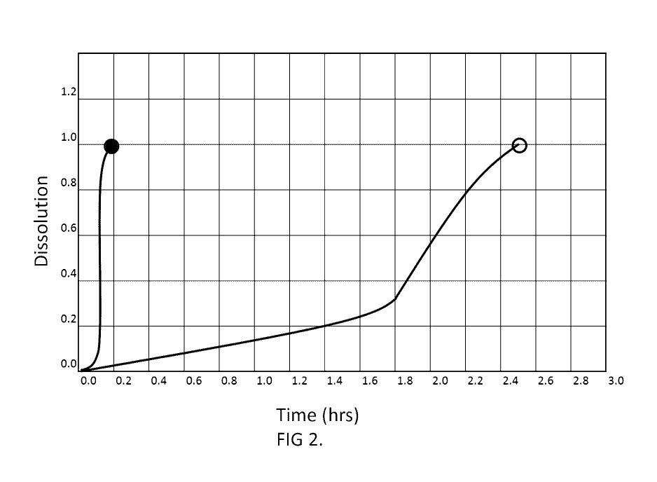

As shown in FIGS. 1 and 2, when a conventional magnetic stir bar (open circles) having a length of 2 inches, was placed in a 500 mL volume of a 2% CMC aqueous compositions at room temperature, the time to achieve 95% dissolution of the CMC was at least 2.5 hours. Both linear and sigmoidal dissolution profiles can be obtained when dissolving CMC, see FIG. 1 and FIG. 2, respectively. The amount of dissolution can be estimated visually by inspecting the mixed composition. For example, a turbidity scale can be examined to determine the amount of dissolution based upon a visual inspection.

In comparison, with the present magnetic stirring devices (closed circles), including the magnetic stirring elements and stirring systems, 95% dissolution of the CMC was obtained in less than 2.5 hours. Thus, the present magnetic stirring devices provide faster and more efficient mixing and/or dissolving compared to existing stirring devices. As shown in FIG. 1 and FIG. 2, with the present magnetic stirring devices, 95% dissolution of the 2% CMC aqueous composition was achieved in less than 10 minutes. For example, embodiments of the present magnetic stirring devices can achieve 95% dissolution of the 2% CMC aqueous composition in about 5 to 7 minutes. In addition, 95% dissolution of a 3% CMC aqueous composition can be achieved in about 7 minutes at room temperature. CMC can be obtained from public sources. For example, one example of CMC is available as BLANOSE™ CMC, grade 7L, DS-Type (Aqualon).

Dissolution of solutes in a liquid, or other phases, can be determined by visually inspecting the composition before, during, or after the stirring or vortexing of the composition. Or, in addition or alternatively, dissolution can be determined using other conventional methods, such as centrifuging, decanting, drying, Gel Permeation Chromatography, and weighing a sample of the composition.

Thus, certain embodiments of the present magnetic stirring elements have structures that provide 95% dissolution of CMC in a 2% CMC aqueous composition in less than 10 minutes at about 20 degrees C.

A 2% CMC aqueous solution at 20 degrees C. can be understood to have a viscosity of about 400 cps to about 800 cps or of about 250 cps to about 500 cps, which viscosity can vary depending on the grade of CMC. CMC can be obtained from any public source, such as Sigma (St. Louis, Mo.) or Aqualon. Thus, although embodiments of the present magnetic stirring devices are described in reference to a CMC-containing composition, the present magnetic stirring devices can provide similar dissolution rates and/or dissolution profiles (as shown in FIGS. 1 and 2) in other liquid-containing compositions. For example, the present magnetic stirring devices can provide 95% dissolution of a substance in a composition having a final viscosity from about 400 cps to about 800 cps in less than about 10 minutes. The present magnetic stirring devices can provide enhanced dissolution rates for more viscous compositions, as well. For example, the present magnetic stirring devices can mix compositions having a viscosity of up to about 1500 cps in much shorter time periods than conventional stirring devices. In certain embodiments, the dissolution rate is at least 60%, at least 70%, at least 80%, or at least 90% faster than conventional magnetic stirring devices.

Advantageously, the present magnetic stirring elements are structured to provide 95% dissolution of the CMC without becoming dislodged so that the stirring element stops stirring the composition. For example, with the present magnetic stirring devices, spin out of the magnetic stirring element is greatly reduced and preferably is eliminated due to the greater stability achieved by the greater magnetic field coverage provided from the present magnetic structure design. For example, since the present magnetic stirring elements create a vortex to generate a mixing of the liquid-containing composition (as opposed to tumbling), the present devices provide the 95% dissolution without or minimizing dislodging the stirring element to stop the vortexing of the liquid containing composition. In other words, with the present magnetic stirring devices, the magnetic stirring element is able to maintain a substantial vortex in the liquid-containing composition without becoming destabilized. For example, the vortex can be maintained even when the actuatable driver magnet of a magnetic stirring system is spinning at high rates, such as at least 1000 rotations per minute (RPM). With the present magnetic stirring devices, the magnetic stirring element can create a vortex in the liquid-containing composition when the actuatable driver magnet rotates from about 60 RPM to about 1800 RPM and can maintain the vortex when the actuatable driver magnet rotates from about 1200 RPM to about 1600 RPM, for example. In certain embodiments, the actuatable driver magnet rotates at a speed grater than 1800 RPM, such as in industrial settings and the like. At these high rotation rates, conventional magnetic stirring elements spin out, especially in viscous composition, such as compositions having a viscosity greater than about 400 cps.

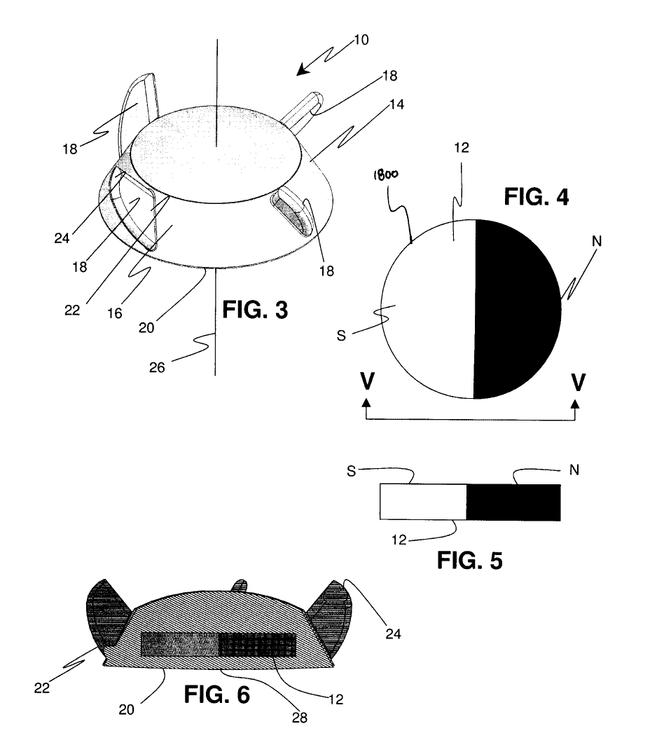

One example of the present magnetic stirring elements is illustrated in FIGS. 3-6. As shown in FIGS. 3-6, a magnetic stirring element 10 comprises a magnet 12 and a coating 14 surrounding the magnet 12. The magnet 12 is a component of a stirring element base 16. A plurality of stirring blades 18 extend from the stirring element base 16. In this embodiment, the magnetic stirring element 10 consists of four stirring blades 18 extending from the stirring element base 16. In other embodiments, the magnetic stirring element comprises at least three stirring blades. In further embodiments, the magnetic stirring element 10 comprises two or more stirring blades 18, such as from two to twelve stirring blades 18.

As illustrated in FIG. 3, the magnetic stirring element base 16 comprises a container-facing surface 20. The container-facing surface 20 refers to the surface of the stirring element base 16 that is oriented toward the bottom surface of a container during rotation of the magnetic stirring element 10. In certain embodiments, the container-facing surface 20 contacts the bottom surface of a container and can be understood to be a container-contacting surface. In reference to the drawings, container facing surface 20 may also be understood to be a bottom surface of the stirring element base 16.

In certain embodiments, the stirring element base comprises a container facing surface selected from the group consisting of planar surfaces, concave surfaces, convex surfaces, and combinations thereof. For example, as shown in FIG. 3, the stirring element base 16 comprises a convex container facing surface 20. As shown in FIG. 15 and FIG. 17, the stirring element base comprises a planar container facing surface. Convex container-contacting surfaces can provide improved stability of the magnetic stirring element as it rotates compared to planar or concave container-contacting surfaces.

Each of the plurality of stirring blades 18 comprises a proximal portion 22 and a distal portion 24. The proximal portion 22 contacts the stirring element base 16. The distal portion 24 is spaced apart from the proximal portion 22 and extends away from the container-facing surface 20 of the stirring element base 16.

The magnetic stirring element base 16 has an axis of rotation 26 or a rotation axis 26. The axis of rotation 26 refers to an imaginary vertical line extending through the center of the stirring element base 16 and is a central region about which the stirring element 10 rotates during a mixing process.

In certain embodiments, including the illustrated embodiments, the plurality of stirring blades 18 are symmetrically disposed relative to the axis of rotation 26. For example, in the embodiment of FIG. 3, each adjacent stirring blade 18 is about ninety degrees apart from the other stirring blade 18. When only two stirring blades are provided on the stirring element base 16, the two blades are about one-hundred eighty degrees apart. When only three stirring blades are provided on the stirring element base 16, the three blades are about one-hundred twenty degrees apart.

As shown in FIG. 4, the magnet 12 of the stirring element 10 is a disk magnet comprising north (N) and south (S) pole portions. In this embodiment, the disk magnet consists of two semi-circular portions, one side of one portion being a north pole and the one side of the second portion being a south pole. In the embodiment of FIG. 4, the first portion and the second portion are two separate semi-circular elements. Each semi-circular element is magnetized in the direction of the faces or surfaces, as shown in FIG. 4. The magnet is magnetized through its thickness. As discussed herein, other magnets of the present devices can be rod magnets (see FIG. 13, for example) or magnets of the present devices can be ring magnets (see FIG. 11, for example). A ring magnet differs from a disk magnet in that the ring magnet includes a hole or void. The ring can be any shape, size, orientation or combinations thereof, and is illustrated as having a cylindrical shape, or a circular cross-section.

It can be understood that a rotating magnetic stirring element that is rotating about its axis of rotation, as shown in FIG. 3, can have a circular magnetic field coverage that lies in the same plane as the magnetic stirring element. The present magnetic stirring elements can comprise a magnet having a magnetic field from about twenty-five degrees to about sixty degrees of a circular magnetic field. Thus, the present magnetic stirring elements can comprise a magnet having a magnetic field that is about 7% to about 17% of a circular magnetic field. For example, like conventional magnetic stirring elements, the magnet of the present magnetic stirring elements can be a rod magnet, such as rod magnet 62 shown in FIG. 13. Rod magnets include magnets having cross-sectional shapes including circles, rectangles, squares, triangles, pentagons, hexagons, octagons, and the like. Rod magnets may be provided in any of the illustrated stirring element bases disclosed herein, or may be provided in a conventional housing when the magnetic stirring element is provided with a magnetic stirring system including a non-bar shaped actuatable driver magnet.

In other embodiments, examples of the present magnetic stirring elements can comprise a magnet having a magnetic field coverage from about 70 degrees to about 360 degrees of a circular imaginary rotation circle 1800. For example, the rotating magnet may have a magnetic field coverage area that is from about 20% to about 100% of the area of imaginary rotation circle 1800. In other embodiments, the total magnetic field coverage angle is from about 90 degrees to 360 degrees, about 100 degrees to 360 degrees, about 150 degrees to 360 degrees, about 200 degrees to 360 degrees, about 230 degrees to 360 degrees, or about 270 degrees to 360 degrees. In certain embodiments, the magnet is selected from the group consisting of disk magnets and ring magnets, as described herein. A ring magnet, such as the ring magnet 52, includes a central void, such as void 54. Preferably, the void is located about the rotation axis of the stirring element.

The present magnetic stirring elements can comprise stirring element bases of a variety of different shapes. For example, in certain embodiments, the stirring element bases are selected from the group consisting of circular bases and polygonal bases. The shape of the base being referred to is the horizontal cross-sectional shape of the stirring element base when the base is located so that its container-facing surface is its bottom surface. Thus, the present stirring element bases can comprise, consist essentially of, or consist entirely of curved edges, one or more straight edges, or combinations thereof. Examples of horizontal cross-sectional shapes of the present stirring element bases include circles, triangles, rectangles, squares, pentagons, hexagons, stars, crosses, fans, saws, and the like. The shape of the magnet should be selected so that the magnet has a 360 degree magnetic field coverage as it rotates in a multi-phase composition.

In addition, the present magnetic stirring elements can comprise a plurality of stirring blades having one or more surfaces of various geometric shapes. For example, in certain embodiments, the plurality of stirring blades has a surface selected from the group consisting of round surfaces, flat surfaces, triangular surfaces, curved surfaces, and combinations thereof. In certain embodiments, the stirring blades comprise lateral surfaces having surface areas no less than 10 mm². For example, one stirring blade can comprise first and second opposing lateral surfaces, each lateral surface having a surface area greater than or equal to 5 mm² for a 5 mL volume of a multi-phase composition. In certain embodiments, the lateral surface of one stirring blade can be as great as 1,000,000 mm² for a 1000 L volume of a multi-phase composition.

As one example, the embodiment of the magnetic stirring element 10 illustrated in FIG. 3 comprises stirring blades 18 that consist of two planar lateral surfaces, a curved first edge surface, a planar opposing second edge surface, and a curved third edge surface extending from the first edge surface to the second edge surface.

Another example of the present magnetic stirring elements is illustrated in FIG. 7. In FIG. 7, parts similar to the embodiment of FIG. 3 are shown by like numbers increased by 100. Thus, it can be understood that a magnetic stirring element 110 comprises a coating or housing 114, a plurality of stirring blades 118, and a container-facing surface 120. In this embodiment, each of the plurality of stirring blades 118 has a vertical cross-sectional shape 119 of a cross or a star.

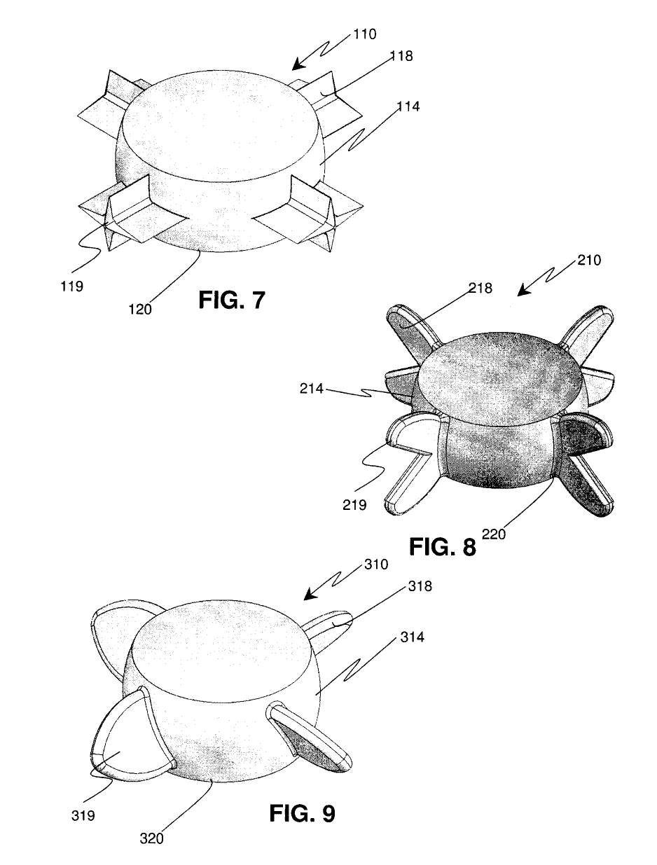

Another example of the present magnetic stirring elements is illustrated in FIG. 8. In FIG. 8, parts similar to the embodiment of FIG. 3 are shown by like numbers increased by 200. Thus, it can be understood that a magnetic stirring element 210 comprises a coating 214, a plurality of stirring blades 218, and a container-facing surface 220. In this embodiment, each of the plurality of stirring blades 218 has a vertical plan shape 219 of a notched blade. For example, a stirring blade 218 has a lower portion and an upper portion. A radial outer edge of the upper portion is spaced apart from the radial outer edge of the lower portion by a central void.

Another example of the present magnetic stirring elements is illustrated in FIG. 9. In FIG. 9, parts similar to the embodiment of FIG. 3 are shown by like numbers increased by 300. Thus, it can be understood that a magnetic stirring element 310 comprises a coating 314, a plurality of stirring blades 318, and a container-facing surface 320. In this embodiment, each of the plurality of stirring blades 318 is shown as a plurality of blades 319 oriented an angle greater than zero degrees relative to the vertical axis of rotation of the magnetic stirring element. In some preferred embodiments, the plurality of blades 319 can be oriented an angle from about zero degrees relative to the vertical axis of rotation of the magnetic stirring element, to about 90 degrees relative to the vertical axis of rotation of the magnetic stirring element.

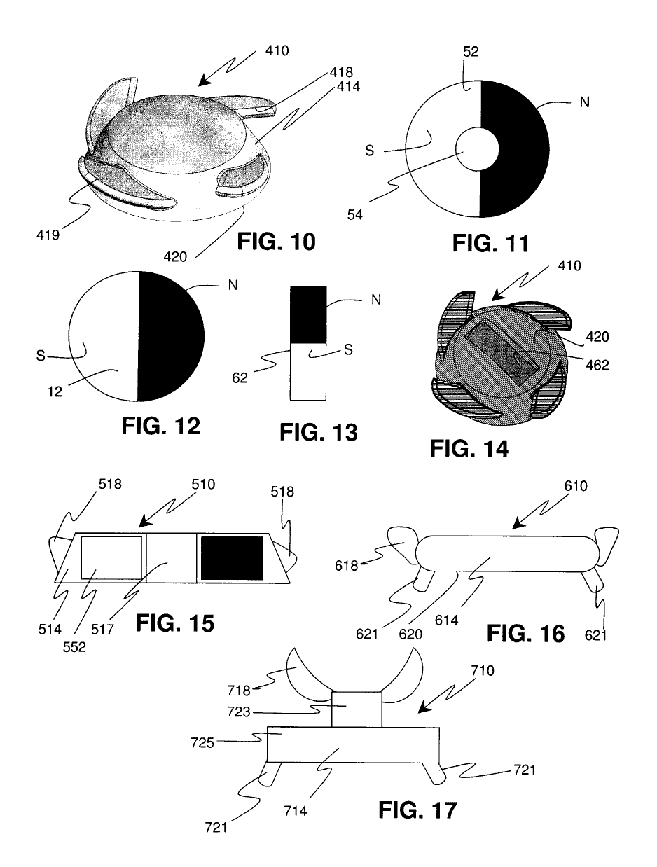

Another example of the present magnetic stirring elements is illustrated in FIG. 10. In FIG. 10, parts similar to the embodiment of FIG. 3 are shown by like numbers increased by 400. Thus, it can be understood that a magnetic stirring element 410 comprises a coating 414, a plurality of stirring blades 418, and a container-facing surface 420. In this embodiment, each of the plurality of stirring blades 418 is shown as a plurality of blades 419 oriented an angle greater than zero degrees relative to the vertical axis of rotation of the magnetic stirring element, and greater than the embodiment of FIG. 9.

In certain embodiments, including the embodiments of FIGS. 9 and 10, the stirring element base has a vertical axis of rotation, and each of the plurality of stirring blades or oriented from about a zero degree angle relative to the vertical axis of rotation to about an eighty degree angle relative to the vertical axis of rotation.

In certain embodiments, the stirring element base of the magnetic stirring element has an upper portion and a lower portion. A first portion or a first set of the plurality of stirring blades extends from the upper portion of the stirring element base, and a second portion or second set of the plurality of stirring blades extends from the lower portion of the stirring element base. Embodiments of such bidirectional magnetic stirring elements are shown in FIGS. 7-9. These bidirectional magnetic stirring elements are preferably completely symmetrical and can provide advantages over other embodiments by permitting placement of the stirring element in a container without regard to the position of the stirring element in the container.

In other embodiments, the stirring element base of the magnetic stirring element comprises only one sidewall, and a bottom surface. Each of the plurality of stirring blades comprises a distal end located the same distance from the bottom surface. Embodiments of such unidirectional magnetic stirring elements are shown in FIGS. 3, 10, 15, 16, and 17. These unidirectional magnetic stirring elements are asymmetric with respect to the vertical positioning of the stirring blades, and the stirring blades point in a single direction. In these embodiments, positioning of the magnetic stirring element is important, and it is desirable that the bottom surface of the stirring element is oriented toward a bottom inner surface of a container.

As shown in FIG. 14, the magnetic stirring element 410 comprises a rod magnet 462. As shown in FIG. 15, the magnetic stirring element 510 comprises a ring magnet 552. The magnetic stirring element 510 includes a central void 517 and therefore defines a ring-shaped magnetic stirring element. Additional embodiments can include more than one void. For example, a stirring element base can comprise an outer peripheral sidewall, and a plurality of stirring blades located within the outer peripheral sidewall and extending from a central region of the stirring element base. This embodiment can be understood to include fan-like or propeller-like blades that cause the magnetic stirring element to levitate from the bottom surface of the container as it rotates about the axis of rotation.

Some embodiments of the present magnetic stirring elements comprise a plurality of stabilizing legs extending from a lower portion of the stirring element base. For example, as shown in FIG. 16, a magnetic stirring element 610 comprises a coating 614, a plurality of stirring blades 618, a container-facing surface 620, and a plurality of stabilizing legs 621. In this embodiment, the magnetic stirring element comprises four stabilizing legs 621. However, in other embodiments, three stabilizing legs can be provided, or more than four can be provided.

Certain embodiments of the present magnetic stirring elements may include regionally isolated stirring blades. One example is shown in FIG. 17. In this embodiment, a magnetic stirring element 710 comprises a coating 714, a plurality of stabilizing legs 721, and a plurality of stirring blades 718. In addition, this embodiment comprises a lower portion 725 and an upper portion 723. The plurality of stirring blades 718 extend from the upper portion 723 of the stirring element base.

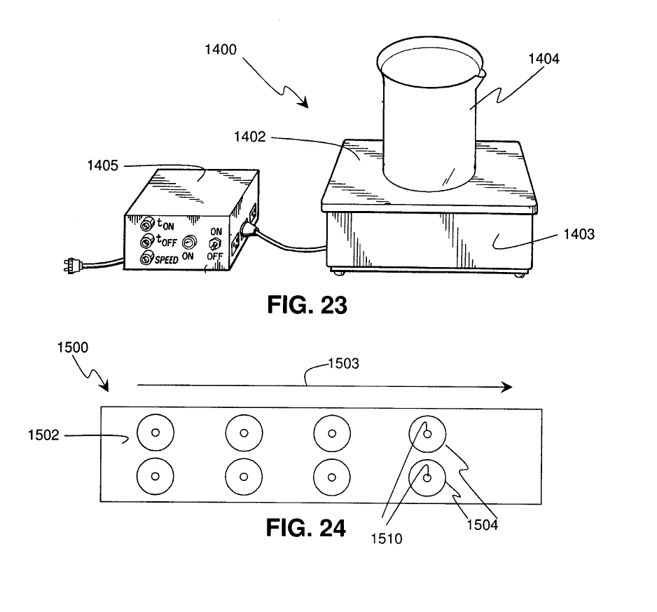

As shown in FIG. 23, and as discussed herein, the present magnetic stirring elements can be a component of a laboratory magnetic stirring system. In addition, as shown in FIG. 24, the present magnetic stirring elements can be a component of a commercial manufacturing system.

In certain embodiments, including some of the illustrated embodiments, the present magnetic stirring elements comprise a round magnet that provides enhanced stability and/or magnetic strength, and a plurality of stirring blades.

The present magnetic stirring elements can be a variety of sizes. For example, the present magnetic stirring elements can have a maximum dimension from about 1 mm to about 90 mm. For example, a bar shaped magnetic stirring element can have a diameter from 1.5 mm to about 8 mm, and a length from about 2 mm to about 85 mm. Disk and ring magnets can have diameters from about 4 mm to about 20 mm, and thickness from about 2 mm to about 25 mm.

One embodiment of the present invention is a magnetic stirring element that comprises, consists essentially of, or consists entirely of a ring magnet and a coating surrounding the magnet. In additional embodiments, the ring magnet can be a component of a magnetic stirring element base, and the stirring element further comprises a plurality of stirring blades radially extending from the stirring element base. The stirring blades can be unidirectional and provided only in a single plane, or can be bidirectional and provided on upper and lower portions of the stirring element base.

Another aspect of the present invention relates to magnetic stirring systems. For example, as shown in FIG. 18, a magnetic stirring system 1000 comprises a container-contacting surface 1002. The container-contacting surface 1002 supports a container 1004 comprising a liquid-containing composition 1006. A magnetic stirring element 1010 is illustrated as being located in composition 1006. The magnetic stirring system 1000 comprises at least one actuatable driver magnet 1012 that is spaced apart from the container-contacting surface 1002. The actuatable driver magnet 1012 is positioned to cause rotation of the magnetic stirring element 1010 that has a structure that, when the stirring element is located in 500 mL of a 2% carboxymethylcellulose (CMC) aqueous composition in a container in contact with the container-contacting surface and dissolving 95% of CMC in the 2% CMC aqueous composition in less than 2.5 hours at about 20 degrees C.

In certain embodiments, the actuatable driver magnet 1012 is effective in causing rotation of the magnetic stirring element 1010 to dissolve 95% of the CMC in less than 10 minutes at about 20 degrees C.

Advantageously, the actuatable driver magnet 1012 is structured to provide the 95% dissolution of the CMC without the magnetic stirring element 1010 becoming dislodged. Being dislodged is defined as a condition where the stirring element stops stirring the composition while a driver magnet continues to rotate. For example, the driver magnet continues to rotate, but spinning of the stirring element went out of sync with the driver magnet, and begins to “dance” and spin-off of the vertical rotation axis. In this situation, the stirring element ends up resting at a bottom corner of the container. As discussed herein, the actuatable driver magnet 1012 cause rotation of the magnetic stirring element 1010 about a vertical axis of rotation to permit a vortex in the liquid-containing composition to be formed. Thus, the vortex in the present compositions can be maintained even at high rotation rates and in high viscosity compositions without the magnetic stirring element spinning out.

The actuatable driver magnet 1012 can comprise any suitable magnetic material. In certain embodiments, the actuatable driver magnet is a neodymium magnet.

Previously the embodiments of the driver magnet were described in terms of magnetic field area coverage in percentile to the area of the imaginary rotation circle. These embodiments can also be described in terms of degrees coverage in relation to the 360 degree periphery of the imaginary rotation circle. In a preferred embodiment, the periphery of the imaginary rotation circle is a complete 360 degree circle, and the terminal ends of the at least one driver magnet produces a magnetic field coverage area that overlaps the periphery of the rotation circle by about 90 to 360 degrees at rest; more preferably, they overlap by about 180 to 360 degrees; even more preferably, they overlap by about 270 to 360 degrees; most preferably, they overlap by about 360 degrees.

For example, the terminal ends of two driver magnets, each having a pie shape, a quarter of a whole circle. These two magnets would overlap the periphery of the rotation circle by 180 degree.

In certain embodiments, the actuatable driver magnet has a magnetic field from about 280 degrees to about 360 degrees of a circular magnetic field. The actuatable driver magnet has a magnetic field coverage of 360 degrees at rest. In other embodiments of the magnetic stirrer system, the actuatable driver magnet provides a magnetic field coverage from about 90 degrees to about 360 degrees as the actuatable driver magnet at rest. One example includes a magnet that provides a magnetic field coverage of at least 180 degrees. Another example includes a magnet that provides a magnetic field coverage from about 270 degrees to 360 degrees. In other embodiments, the magnetic field coverage is from about 90 degrees to 360 degrees, about 100 degrees to 360 degrees, about 150 degrees to 360 degrees, about 200 degrees to 360 degrees, about 230 degrees to 360 degrees, or about 270 degrees to 360 degrees. For example, the present magnetic stirrer systems can comprise an actuatable driver magnet selected from the group consisting of disk magnets and ring magnets. As shown in FIGS. 18-21, the actuatable driver magnet 1012 is a ring magnet 1014. The ring magnet 1014 is operably coupled, either directly or indirectly, to a motor 1022 or other drive mechanism by a connector 1016. The ring magnet 1014 consists of a semi-annular north pole portion 1018 and a semi-annular south pole portion 1020. The ring magnet 1014 is coupled to the connector 1016 by an attachment element 1024. The axis of rotation 1026 of this actuatable driver magnet 1012 is shown in FIG. 21.

As shown in FIG. 22, a non-disk or non-ring actuatable driver magnet 1112 is illustrated. In this embodiment, the actuatable driver magnet 1112 has a greater magnetic field than conventional magnetic bars used in stirrer plates. For example, the actuatable driver magnet 1112 comprises a north pole portion 1118 and an opposing south pole portion 1120. An attachment element 1124 is located between portion 1118 and portion 1120. The rotation axis is illustrated at 1126. Thus, this embodiment can be understood to comprise a first end, an opposing second end, and an intermediate portion there between. The first end and the second end each have a width greater than the width of the intermediate portion. In addition, this embodiment can be understood to have a length 1128 and a magnetic field coverage that is greater than a magnetic field coverage of a second rod-shaped actuatable driver magnet having the same length. Additional actuatable driver magnets are illustrated in FIG. 30.

The present magnetic stirring systems can be provided as stand alone systems or can be provided in combination with one or more magnetic stirring elements, including the magnetic stirring elements described herein. Thus, magnetic stirring systems can be made available to consumers as a separate housing containing an actuatable driver magnet, or they can be made available as kits that comprise such a housing with one or more magnetic stirring elements, such as a batch of magnetic stirring elements of different configurations.

Embodiments of the present invention relate to various combinations of magnetic stirring systems and magnetic stirring elements.

For example, in one embodiment, a magnetic stirring system comprises an actuatable driver magnet selected from the group consisting of disk magnets and ring magnets as showed in FIG. 30, and a magnetic stirring element that comprises a rod magnet. For example, this embodiment can be understood to be a magnetic stirring system that comprises a disk or ring magnet and any conventional or existing magnetic stirring elements. In other embodiments, examples of the present magnetic stirring systems can comprise a magnet having a total magnetic field coverage angle as the magnet rotates from about 90 degrees to about 360 degrees of a circular magnetic field.

In another embodiment, a magnetic stirring system comprises an actuatable driver magnet selected from the group consisting of disk magnets and ring magnets, and a magnetic stirring element that comprises a disk magnet or a ring magnet. For example, this embodiment can be understood to be a magnetic stirring system that comprises a disk or ring magnet and any disk or ring magnets disclosed herein. In certain embodiments, the actuatable driver magnet and the stirring element magnet have a form as shown by one of the magnets shown in FIG. 30.

In another embodiment, a magnetic stirring system comprises an actuatable driver magnet that is a rod magnet, and a magnetic stirring element that comprises a rod magnet. For example, this embodiment can be understood to be a conventional magnetic stirring system that comprises a rod or bar magnet and a magnetic stirring element having any of the various configurations of magnetic stirring element bases disclosed herein, including those in FIG. 31. For example, the magnetic stirring element may comprise a stirring element base comprising a magnet, including a rod magnet, and a plurality of stirring blades radially extending from the stirring element base.

In another embodiment, a magnetic stirring system comprises an actuatable driver magnet which is a rod magnet, and a magnetic stirring element that comprises a disk magnet or a ring magnet. For example, this embodiment can be understood to be a conventional magnetic stirring system that comprises a rod magnet or rod stir bar and any disk or ring magnets disclosed herein.

The present magnetic stirrer systems can be provided in a laboratory. For example, as shown in FIG. 23, a laboratory magnetic stirring system 1400 is illustrated as comprising a container-contacting surface 1402, a housing 1403, and a container 1404. Although a control device 1405 is illustrated as a separate component from the housing 1403, additional embodiments include a housing 1403 with integral control components to actuate the actuatable driver magnet located in the housing 1403. The present systems can also include a temperature control device, such as a heater or cooler. For example, a stir plate of the present embodiments may also be understood to be a heating plate with stirring capabilities.

In addition, embodiments of the present magnetic stirrer systems may be a component of a commercial manufacturing systems or commercial diagnostic system. For example, the present stirrer systems can be provided at one or more stations in a pilot manufacturing line or a full-scale automated manufacturing line. One embodiment is shown in FIG. 24. In this embodiment, a magnetic stirrer system 1500 comprises a container-contacting surface 1502. The container-contacting surface is illustrated as being a surface of a conveyor assembly. A plurality of containers 1504 containing magnetic stirring elements 1510 are provided on the container contacting surface 1502 (only two of the containers 1504 are illustrated for clarity). The containers 1504 move in direction of arrow 1503 along the conveyor line. The liquid-containing compositions present in the containers 1504 can be stirred by the magnetic stirring elements 1510 while they move along the conveyor or in stationary positions along the conveyor.

In addition, the present magnetic stirring systems can comprise a plurality of actuatable driver magnets. For example, where a plurality of containers are desired to be mixed, a plurality of actuatable driver magnets may be desirable.

The present magnetic stirring elements can be made using conventional methods known to persons of ordinary skill in the art. For example, the stirring element base can be made using stereolithography. A cavity can be created in the base, and a magnet can be placed in the cavity. Or, a mold, such as a silicone mold, can be made from the stereolithographically generated base. A plastic material can be poured into the mold to generate the stirring element base. The cavity can be made during the casting of the base or later. The magnet is inserted in the cavity. A resin material can be added to the cavity to seal the magnet within the cavity. The base can be machined if desired to provide a smooth surface.

The present systems can be made by providing an actuatable driver magnet at a distance from a container-contacting surface. A container containing a liquid-containing composition is placed on the container-contacting surface. A magnetic stirring element is placed in the liquid-containing composition. The actuatable driver magnet is actuated, such as by turning on a motor coupled to the actuatable driver magnet, and causes rotation of the magnetic stirring element in the liquid-containing composition. When a desired level of mixing has been achieved, the motor can be turned off and the rotation of the magnetic stirring element is stopped.

Methods of using the present magnetic stirring devices are encompassed. For example, in one embodiment, a method for mixing a liquid-containing composition comprises using the present magnetic stirring elements, magnetic stirring systems, and combinations thereof.

In one contemplated embodiment, the method stabilizes a stir bar when mixing solid and liquid inside a laboratory beaker. Contemplated method steps include placing said liquid and said solid into said laboratory beaker; submersing said stir bar into said liquid, wherein said stir bar encloses a magnet and the stir bar is free from stationary attachment to said beaker; placing said beaker on top of a magnetic stirrer, wherein said magnetic stirrer has a first and second driver magnets; rotating said first and second driver magnets about a vertical rotational axis, wherein the first and second driver magnets each has a north-south polarity parallel to said axis; allowing said stir bar to rest at a bottom of the beaker and to self-align with the first driver magnet according to south pole-to-north pole magnetic attractions; after the stir bar self-aligns with said first driver magnet, and when the first and second driver magnets are at rest, allowing said stir bar a free range of spin about the axis where a magnitude of magnetic attraction force between a north pole of the stir bar and a south pole of said first driver magnet remains substantially the same, wherein the free range is between zero degree to at least 160 degrees but no more than 180 degrees; when the first and second driver magnets begin to rotate, allowing the stir bar to lag behind and move at least 160 degrees within said free range of spin due to inertia, until the north pole has reached the end of the free range. Further discussion this freedom of movement is discussed below in FIG. 27B.

In one embodiment, the free range of spin allows the stir bar to move between zero to at least 160 degrees without changing a strength of magnetic attraction between the north pole of the stir bar and the south pole of the first driver magnet.

In another embodiment, the method includes providing consistent torque to stir bars of various lengths. This can be done by providing a first driver magnet in a magnetic stirrer, wherein the first driver magnet has a half-circular shape cross sectional to its north-south direction; providing a second driver magnet adjacent to the first driver magnet, wherein the second driver magnet has a half-circular shape cross sectional to its north-south direction; wherein the first and second driver magnets combine to create a full circle; each of said first and second driver magnets having a straight edge where the first driver magnet is adjacent the second driver magnet; placing a relatively shorter magnetic stir bar into a beaker; placing said beaker onto the magnetic stirrer; removing said relatively shorter magnetic stir bar; placing a relatively longer magnetic stir bar into said beaker; placing said beaker onto the magnetic stirrer; and wherein the torque exerted on the shorter magnetic stir bar and the longer magnetic stir bar are substantially the same.

In more detail, a method comprises providing a magnetic stirring element in a liquid-containing composition in a container, and providing the container on a container-contacting surface of a magnetic stirring system. The magnetic stirring element can be provided in the container first or the container can be provided on the container contacting surface first. The method comprises rotating the magnetic stirring element by actuating an actuatable driver magnet of the magnetic stirring system. The magnetic stirring element of the present methods has a structure that, when the stirring element is located in 500 mL of a 2% carboxymethylcellulose (CMC) aqueous composition in a container on a stirring system and is caused to rotate by the stirring system, provides 95% dissolution of CMC in the 2% CMC aqueous composition in less than 2.5 hours at about 20 degrees C.

As discussed herein, in certain embodiments, including the illustrated embodiment, the magnetic stirring element is structured to provide 95% dissolution of the CMC in less than 10 minutes at about 20 degrees C. The rotating can be performed without the magnetic stirring element becoming dislodged so that the stirring element stops stirring the composition.

In certain embodiments, as discussed herein, the magnetic stirring element comprises a stirring element base comprising a magnet, and the stirring element further comprises a plurality of stirring blades extending from the stirring element base.

In certain embodiments, as discussed herein, the liquid-containing composition comprises a solvent, including, without limitation, organic solvents. In certain embodiments, the liquid-containing composition comprises water. In certain embodiments, the liquid-containing composition comprises soluble particles.

In certain embodiments of the present methods, the actuatable driver magnet is selected from the group consisting of disk magnets and ring magnets.

The present methods may be performed in a laboratory or may be a step or component of a commercial manufacturing process.

With the present stirring devices, including stirring elements and stirring systems, and stirring methods, a liquid-containing composition can be stirred by creating a vortex in the liquid-containing composition. Thus, the present magnetic stirring elements can be understood to be vortex stirring elements in contrast to tumbling stirring elements. In comparison to magnetic stirrers that do not want aeration to be present in the mixing of compositions, embodiments of the present magnetic stirring devices can stir a liquid-containing composition without regard to aeration. For example, the stirring can occur with bubble formation in the liquid.

In view of the disclosure herein, it can be appreciated that the present magnetic stirring devices provide relatively easier dissolution of hard-to-dissolve compounds in liquids and/or provide relatively easier vortexing of viscous liquids, including solutions, compared to existing magnetic stirring devices. The present magnetic stirring devices provide better stability of the magnetic stirring element as it rotates. With the present magnetic stirring elements and stirrer plates, faster mixing rates can be achieved compared to conventional stirrer bars and stirrer plates, as shown in FIGS. 1 and 2, for example.

With the present magnetic stirring devices, it is possible to provide increased mixing speed, which results in a decreased mixing time, increased stability, which results in reduced spin outs of the magnetic stirring element, especially at high speeds, provide enhanced shearing, cutting, and dispersion functions, provides enhanced turbulence and vortexing effects to provide more mixing volume; more effective mixing, dispersing, and dissolving of low, medium, and high viscosity materials and particles; stability of the magnetic stirring element is not impaired in curved bottom containers or vessels; more effective transmission of torque loads compared to conventional stir bars; and reduced noise.

The present stirring devices permit a liquid-containing composition to be vigorously mixed or stirred without any other devices in a container except for the completely submerged magnetic stirring element. For example, the magnetic stirring element can be rotated about a vertical axis of rotation using a magnetic driver located completely out of the container. The present magnetic stirring elements can achieve efficient mixing with enhanced stability without having a hub or positioning cage. Embodiments of the present magnetic stirring elements are free of any flexible finger projections extending from the stirring element base. Stirring can be accomplished in either open or closed containers. In certain embodiments, the actuatable driver magnet comprises only one magnet.

Magnetic stirrer system and magnetic stirring elements have been known for many years. It is of utmost importance that the two has adequate attraction/propelling force towards each other so that rotation of the stirring element corresponds well with the rotation of the driving magnet. Therefore, stronger attraction between the two may appear to provide desired coordination, and minimize “spin-off” or “dancing” of the stirring element. One skilled in the art might have thought that providing a driving magnet with stronger magnetic force may provide the needed stability. Others might have thought that providing a magnet with stronger magnetic force in the stirring element may provide the needed stability. Stronger magnetic force does not necessarily provide stability, and it unnecessarily and undesirably increase production cost.

As for some of the embodiments in the instant application where broader magnetic coverage area is used, one skilled in the art would have avoided such concept. To the contrary, those skilled in the art have recognized the importance of having rather small magnetic coverage areas to provide the desired stability.

The prior art teaches against having a rather large magnetic coverage area. Take the example of a typical driver magnet using a rod magnet to drive a stirring bar (also having a rod magnet). Here, whether the driver magnet has a north pole-to-south pole orientation that parallels the vertical rotation axis, or perpendicular to the vertical rotation axis, the rod driver magnet generally desirably has two small magnetic coverage areas. The small magnetic coverage area gives the stirring bar limited room for rotation. When the driver magnet of this type rotates in a clockwise fashion, the stirring bar immediately follows. When the same driver magnet changes direction and rotates counter-clockwise, the stirring bar immediately changes direction and follows. At rest, the “concentrated” rather small magnetic coverage areas of the rod-type driver magnet prevent the stirring bar from moving in both clockwise and counter-clockwise direction. In a sense, the stirring bar is “locked” in one position (see FIG. 27A). One skilled in the art would immediately recognize this as the preferred and desired method to drive a stirring element. In some of the preferred embodiments disclosed in instant application, however, stirring elements are not “locked” in one position (see FIG. 27B). For example, where the driver magnet is comprised of two half-disk magnets magnetized through thickness, a typical stirrer bar (having a rod magnet within) still has a relatively large freedom of rotational movement (see “F” in FIG. 27B) when the driver magnet is at rest, because the magnetic coverage area is rather large. In almost half of the circular area, a pole of the stirring bar is attracted to and retained within the magnetic field in this half of the circular area. And because the strength of the magnetic field within this half of the circular area is substantially the same, the pole of the stirring bar attracted to this magnetic field can freely move about in this rather broad magnetic coverage area. One of ordinary skill in the art would have immediately recognized this design as undesirable, since freedom of movement in the stirring element can be perceived to contribute to unstability during rotation. While one skilled in the art recognizes that stronger magnets would improve stability in spinning the stirrer bar, one skilled in the art would avoid using magnets having relative large magnetic field coverage area so as to improve stability. Known driver magnets, such as U.S. Pat. No. 6,517,231 that discloses driver magnet having multiple magnets, do not deviate from this generally accepted concept. In U.S. Pat. No. 6,517,231, multiple driver magnets are used, and each driver magnet offers relatively small magnetic field coverage area, so that stirrer bar are “locked” in position with relatively small freedom of movement (see “F” in FIG. 27A).

One of the concepts used in contemplated embodiments is to provide a magnet configuration where the magnetic field strength does not get weaker toward the center of the vertical rotation axis. This is accomplished by providing magnets that are magnetized through thickness, by having magnetic fields towards the center of the vertical rotation axis, and/or by other ways discussed in this disclosure.

While this invention has been described with respect to various specific examples and embodiments, it is to be understood that the invention is not limited thereto and that it can be variously practiced with the scope of the following claims. Multiple variations and modifications to the disclosed embodiments will occur, to the extent not mutually exclusive, to those skilled in the art upon consideration of the foregoing description. For example, the present magnetic stirring elements can be disposable or reusable. In addition, the magnetic stirring elements can be sterilized elements, including heat sterilized elements or chemically sterilized elements. Sterilized elements can be provided in sealed containers or packages. Additionally, other combinations, omissions, substitutions and modifications will be apparent to the skilled artisan in view of the disclosure herein. Accordingly, the present invention is not intended to be limited by the disclosed embodiments, but is to be defined by reference to the appended claims.

What is claimed is:

1. A method of stabilizing a stir bar when mixing solid and liquid inside a laboratory beaker, said method comprising:
placing said liquid and said solid into said laboratory beaker;
submersing said stir bar into said liquid, wherein said stir bar encloses a magnet and the stir bar is free from stationary attachment to said beaker;
placing said beaker on top of a magnetic stirrer, wherein said magnetic stirrer has a first and second driver magnets;
rotating said first and second driver magnets about a vertical rotational axis, wherein the first and second driver magnets each has a north-south polarity parallel to said axis;
allowing said stir bar to rest at a bottom of the beaker and to self-align with the first driver magnet according to south pole-to-north pole magnetic attractions;
after the stir bar self-aligns with said first driver magnet, and when the first and second driver magnets are at rest, allowing said stir bar a free range of spin about the axis where a magnitude of magnetic attraction force between a north pole of the stir bar and a south pole of said first driver magnet remains substantially the same, wherein the free range is between zero degree to at least 160 degrees but no more than 180 degrees;
when the first and second driver magnets begin to rotate, allowing the stir bar to lag behind and move at least 160 degrees within said free range of spin due to inertia, until the north pole has reached the end of the free range.

2. The method as recited in claim 1 further comprising the step of providing said first and second driver magnets to each having a half-circular shape or an arc shape.

3. The method as recited in claim 1, wherein the free range of spin allows the stir bar to move between zero to at least 160 degrees without changing a strength of magnetic attraction between the north pole of the stir bar and the south pole of the first driver magnet.

4. A method of providing consistent torque to stir bars of various length, said method comprising:
providing a first driver magnet in a magnetic stirrer, wherein the first driver magnet has a half-circular shape cross sectional to its north-south direction;
providing a second driver magnet adjacent to the first driver magnet, wherein the second driver magnet has a half-circular shape cross sectional to its north-south direction;
wherein the first and second driver magnets combine to create a full circle;
each of said first and second driver magnets having a straight edge where the first driver magnet is adjacent the second driver magnet.
placing a relatively shorter magnetic stir bar into a beaker;
placing said beaker onto the magnetic stirrer;
removing said relatively shorter magnetic stir bar;
placing a relatively longer magnetic stir bar into said beaker;
placing said beaker onto the magnetic stirrer;
wherein the torque exerted on the shorter magnetic stir bar and the longer magnetic stir bar are substantially the same.

5. A magnetic stirring system, consisting of:
a housing;
a motor within the housing;
two driving magnets within said housing coupled to an axle which is rotatably driven by said motor;
wherein the at least two driving magnets are disposed adjacent to each other;
a beaker;
a stir bar disposed within the beaker and is free from stationary coupling to the beaker;
wherein the two driving magnets combine to create a full circular driving magnetic plate;
a control switch on the housing to control the motor.

6. The stirring system of claim 5, wherein the two driving magnets each has a north-to-south direction parallel to the axle.

7. The stirring system of claim 5, wherein the stir bar is an elongated bar containing a magnet.

8. The stirring system of claim 5, wherein the stir bar has a free range of spin about said axle, from 0 degree to at least 160 degrees, wherein a magnitude of magnetic attraction force between a north pole of the stir bar and a south pole of one of the two driving magnets remains substantially the same within said free range of spin.

9. The stirring system of claim 5, wherein the two driving magnets performs a “push-and-pull” action on the stir bar.
